(19) United States
(12) Patent Application Publication
(10) Pub. No.: US 2022/0124537 A1
(43) Pub. Date: Apr. 21, 2022

(54) METHOD AND APPARATUS FOR CSI REPORTING BASED ON A PORT SELECTION CODEBOOK

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 17/503,224

(22) Filed: Oct. 15, 2021

Related U.S. Application Data
(60) Provisional application No. 63/094,061, filed on Oct. 20, 2020.
(60) Provisional application No. 63/144,290, filed on Feb. 1, 2021.
(60) Provisional application No. 63/187,317, filed on May 11, 2021.
(60) Provisional application No. 63/192,389, filed on May 24, 2021.
(60) Provisional application No. 63/232,042, filed on Aug. 11, 2021.
(60) Provisional application No. 63/235,410, filed on Aug. 20, 2021.
(60) Provisional application No. 63/236,504, filed on Aug. 24, 2021.

(51) Int. Cl. H04W 24/10

(52) U.S. Cl. CPC H04W 24/10; H04B 7/0456

(57) ABSTRACT

A method for operating a user equipment (UE) comprises receiving information about a channel state information (CSI) report, the information including information about two numbers for basis vectors, N and M_{ν}, where N≥M_{ν}; identifying N consecutive basis vectors with indices Mᵢₙᵢₜ+i, i=0,1, . . . , N−1 starting at index Mᵢₙᵢₜ, wherein the N consecutive basis vectors belong to a set of N₃ basis vectors, and N≤N₃; determining M_{ν} basis vectors, wherein: when N=M_{ν}, the M_{ν} basis vectors=the N consecutive basis vectors, and when N>M_{ν}, the M_{ν} basis vectors are selected from the N consecutive basis vectors; determining the CSI report based on the M_{ν} basis vectors, wherein when N>M_{ν}, the CSI report includes an indicator indicating an information about the selected M_{ν} basis vectors; and transmitting the CSI report including the indicator indicating the information about the selected M_{ν} basis vectors when N>M_{ν}.

### CROSS-REFERENCE TO RELATED APPLICATIONS AND CLAIM OF PRIORITY

The present application claims priority to U.S. Provisional Patent Application No. 63/094,061, filed on Oct. 20, 2020; U.S. Provisional Patent Application No. 63/144,290, filed on Feb. 1, 2021; U.S. Provisional Patent Application No. 63/187,317, filed on May 11, 2021; U.S. Provisional Patent Application No. 63/192,389, filed on May 24, 2021; U.S. Provisional Patent Application No. 63/232,042, filed on Aug. 11, 2021; U.S. Provisional Patent Application No. 63/235,410, filed on Aug. 20, 2021; and U.S. Provisional Patent Application No. 63/236,504, filed on Aug. 24, 2021. The content of the above-identified patent documents is incorporated herein by reference.

### TECHNICAL FIELD

The present disclosure relates generally to wireless communication systems and more specifically to CSI reporting based on a codebook.

### BACKGROUND

Understanding and correctly estimating the channel between a user equipment (UE) and a base station (BS) (e.g., gNode B (gNB)) is important for efficient and effective wireless communication. In order to correctly estimate the DL channel conditions, the gNB may transmit a reference signal, e.g., CSI-RS, to the UE for DL channel measurement, and the UE may report (e.g., feedback) information about channel measurement, e.g., CSI, to the gNB. With this DL channel measurement, the gNB is able to select appropriate communication parameters to efficiently and effectively perform wireless data communication with the UE.

### SUMMARY

Embodiments of the present disclosure provide methods and apparatuses to enable channel state information (CSI) reporting based on a codebook in a wireless communication system.

In one embodiment, a UE for CSI reporting in a wireless communication system is provided. The UE includes a transceiver configured to receive information about a channel state information (CSI) report, the information including information about two numbers for basis vectors, N and M_{ν}, where N≥M_{ν}. The UE further includes a processor operably connected to the transceiver. The processor, based on the information, is configured to: identify N consecutive basis vectors with indices Mᵢₙᵢₜ+i, i=0,1, . . . , N−1 starting at index Mᵢₙᵢₜ, wherein the N consecutive basis vectors belong to a set of N₃ basis vectors, and N≤N₃; determine M_{ν} basis vectors, wherein: when N=M_{ν}, the M_{ν} basis vectors=the N consecutive basis vectors, and when N>M_{ν}, the M_{ν} basis vectors are selected from the N consecutive basis vectors; and determine the CSI report based on the M_{ν} basis vectors, wherein when N>M_{ν}, the CSI report includes an indicator indicating an information about the selected M_{ν} basis vectors. The transceiver is further configured to transmit the CSI report including the indicator indicating the information about the selected M_{ν} basis vectors when N>M_{ν}.

In another embodiment, a BS in a wireless communication system is provided. The BS includes a processor configured to generate information about a channel state information (CSI) report, the information including information about two numbers for basis vectors, N and M_{ν}, where N≥M_{ν}. The BS further includes a transceiver operably connected to the processor. The transceiver is configured to: transmit the information; and receive the CSI report, wherein: the CSI report is based on M_{ν} basis vectors, wherein: N consecutive basis vectors are identified with indices Mᵢₙᵢₜ+i, i=0,1, . . . , N−1 starting at index Mᵢₙᵢₜ, wherein the N consecutive basis vectors belong to a set of N₃ basis vectors, and N≤N₃, when N=M_{ν}, the M_{ν} basis vectors=N consecutive basis vectors, when N>M_{ν}, the M_{ν} basis vectors are selected from the N consecutive basis vectors, and the CSI report includes an indicator indicating an information about the selected M_{ν} basis vectors when N>M_{ν}.

In yet another embodiment, a method for operating a UE is provided. The method comprises: receiving information about a channel state information (CSI) report, the information including information about two numbers for basis vectors, N and M_{ν}, where N≥M_{ν}; identifying N consecutive basis vectors with indices Mᵢₙᵢₜ+i, i=0, 1, . . . , N−1 starting at index Mᵢₙᵢₜ, wherein the N consecutive basis vectors belong to a set of N₃ basis vectors, and N≤N₃; determining M_{ν} basis vectors, wherein: when N=M_{ν}, the M_{ν} basis vectors=the N consecutive basis vectors, and when N>M_{ν}, the M_{ν} basis vectors are selected from the N consecutive basis vectors; determining the CSI report based on the M_{ν} basis vectors, wherein when N>M_{ν}, the CSI report includes an indicator indicating an information about the selected M_{ν} basis vectors; and transmitting the CSI report including the indicator indicating the information about the selected M_{ν} basis vectors when N>M_{ν}.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4A illustrates a high-level diagram of an orthogonal frequency division multiple access transmit path according to embodiments of the present disclosure;

FIG. 4B illustrates a high-level diagram of an orthogonal frequency division multiple access receive path according to embodiments of the present disclosure;

FIG. 5 illustrates a transmitter block diagram for a PDSCH in a subframe according to embodiments of the present disclosure;

FIG. 6 illustrates a receiver block diagram for a PDSCH in a subframe according to embodiments of the present disclosure;

FIG. 7 illustrates a transmitter block diagram for a PUSCH in a subframe according to embodiments of the present disclosure;

FIG. 8 illustrates a receiver block diagram for a PUSCH in a subframe according to embodiments of the present disclosure;

FIG. 9 illustrates an example antenna blocks or arrays forming beams according to embodiments of the present disclosure;

FIG. 10 illustrates an antenna port layout according to embodiments of the present disclosure;

FIG. 11 illustrates a 3D grid of oversampled DFT beams according to embodiments of the present disclosure;

FIG. 12 illustrates an example of a port selection codebook that facilitates independent (separate) port selection across SD and FD, and that also facilitates joint port selection across SD and FD according to embodiments of the present disclosure;

FIG. 13 illustrates an example aperiodic CSI trigger state sub-selection MAC CE according to embodiments of the present disclosure;

FIG. 14 illustrates an example semi-persistent (SP) CSI reporting on PUCCH activation/deactivation MAC CE according to embodiments of the present disclosure;

FIG. 15 illustrates an example illustration of a window-based intermediate basis set according to embodiments of the present disclosure;

FIG. 16 illustrates a flow chart of a method for operating a UE according to embodiments of the present disclosure; and

FIG. 17 illustrates a flow chart of a method for operating a BS according to embodiments of the present disclosure.

### DETAILED DESCRIPTION

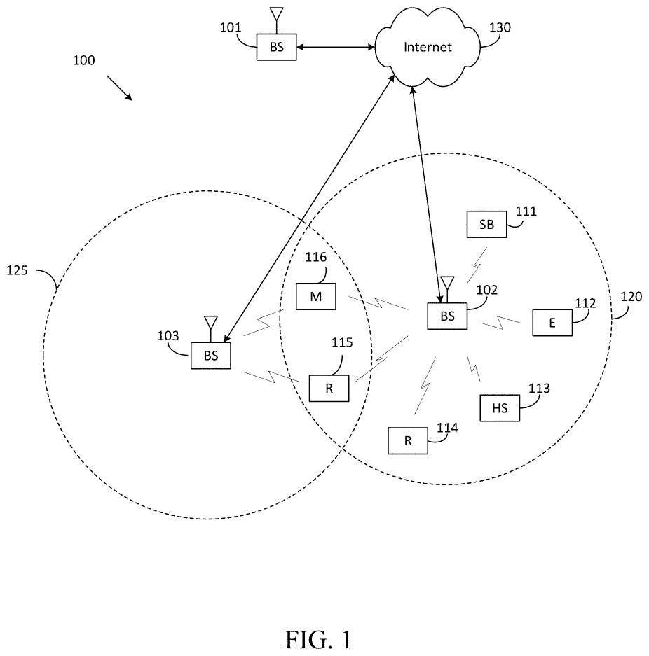

FIG. 1 through FIG. 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 36.211 v16.6.0, “E-UTRA, Physical channels and modulation” (herein “REF 1”); 3GPP TS 36.212 v16.6.0, “E-UTRA, Multiplexing and Channel coding” (herein “REF 2”); 3GPP TS 36.213 v16.6.0, “E-UTRA, Physical Layer Procedures” (herein “REF 3”); 3GPP TS 36.321 v16.6.0, “E-UTRA, Medium Access Control (MAC) protocol specification” (herein “REF 4”); 3GPP TS 36.331 v16.6.0, “E-UTRA, Radio Resource Control (RRC) protocol specification” (herein “REF 5”); 3GPP TR 22.891 v14.2.0 (herein “REF 6”); 3GPP TS 38.212 v16.6.0, “E-UTRA, NR, Multiplexing and channel coding” (herein “REF 7”); and 3GPP TS 38.214 v16.6.0, “E-UTRA, NR, Physical layer procedures for data” (herein “REF 8”).

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system. The present disclosure covers several components which can be used in conjunction or in combination with one another, or can operate as standalone schemes.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for receiving information about a channel state information (CSI) report, the information including information about two numbers for basis vectors, N and M_{ν}, where N≥M_{ν}; identifying N consecutive basis vectors with indices Mᵢₙᵢₜ+i, i=0,1, . . . , N−1 starting at index Mᵢₙᵢₜ, wherein the N consecutive basis vectors belong to a set of N₃ basis vectors, and N≤N₃; determining M_{ν} basis vectors, wherein: when N=M, the M_{ν} basis vectors=the N consecutive basis vectors, and when N>M_{ν}, the M_{ν} basis vectors are selected from the N consecutive basis vectors; determining the CSI report based on the M_{ν} basis vectors, wherein when N>M_{ν}, the CSI report includes an indicator indicating an information about the selected M_{ν} basis vectors; and transmitting the CSI report including the indicator indicating the information about the selected M_{ν} basis vectors when N>M_{ν}. One or more of the gNBs 101-103 includes circuitry, programing, or a combination thereof, for generating information about a channel state information (CSI) report, the information including information about two numbers for basis vectors, N and M_{ν}, where N≥M_{ν}; transmitting the information; and receiving the CSI report, wherein: the CSI report is based on M_{ν} basis vectors, wherein: N consecutive basis vectors are identified with indices Mᵢₙᵢₜ+i, i=0,1, . . . , N−1 starting at index Mᵢₙᵢₜ, wherein the N consecutive basis vectors belong to a set of N₃ basis vectors, and N≤N₃, when N=M_{ν}, the M_{ν} basis vectors=N consecutive basis vectors, when N>M_{ν}, the M_{ν} basis vectors are selected from the N consecutive basis vectors, and the CSI report includes an indicator indicating an information about the selected M_{ν} basis vectors when N>M_{ν}.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

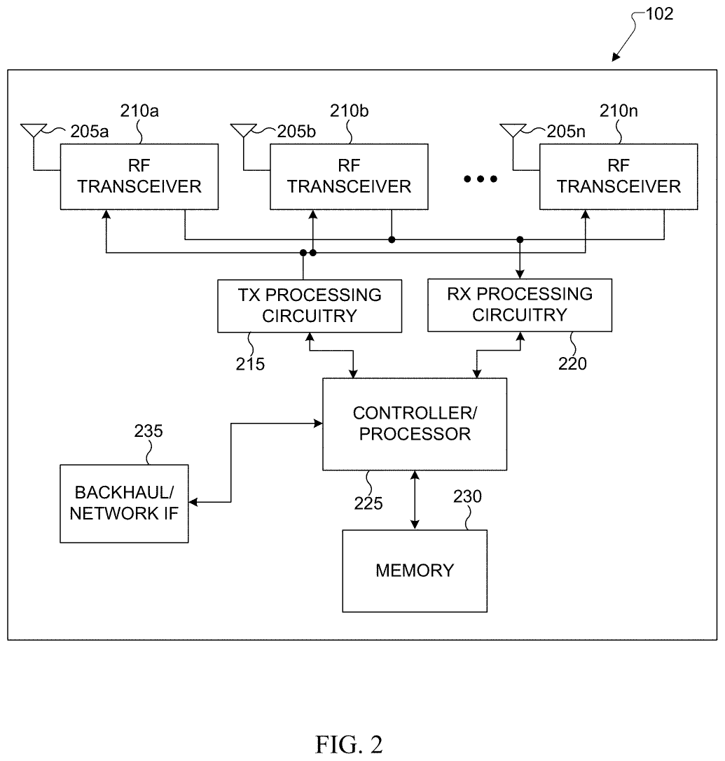

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions.

For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

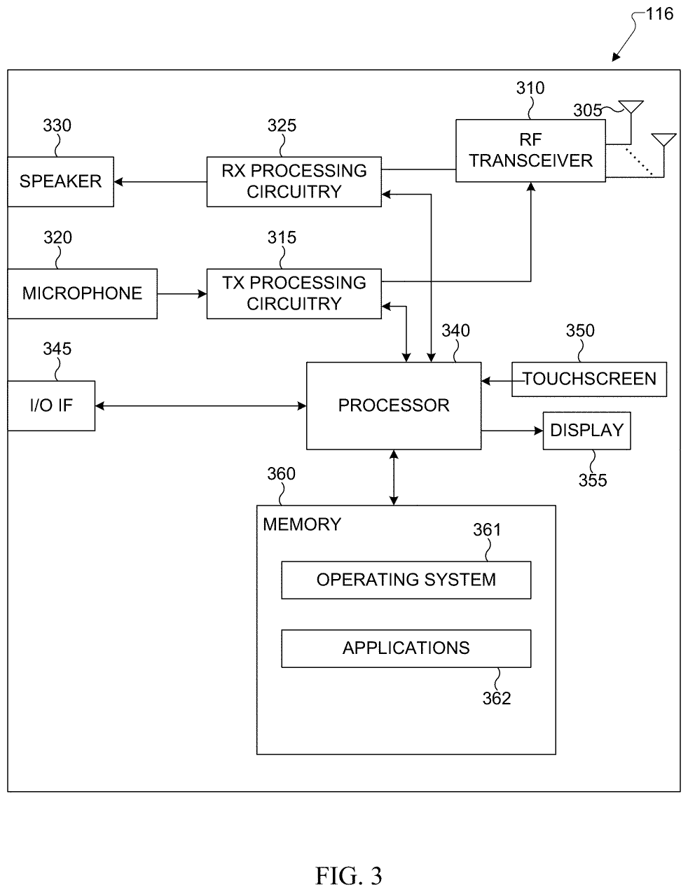

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for receiving information about a channel state information (CSI) report, the information including information about two numbers for basis vectors, N and M_{ν}, where N≥M_{ν}; identifying N consecutive basis vectors with indices Mᵢₙᵢₜ+i, i=0,1, . . . , N−1 starting at index Mᵢₙᵢₜ, wherein the N consecutive basis vectors belong to a set of N₃ basis vectors, and N≤N₃; determining M_{ν} basis vectors, wherein: when N=M_{ν}, the M_{ν} basis vectors=the N consecutive basis vectors, and when N>M_{ν}, the M_{ν} basis vectors are selected from the N consecutive basis vectors; determining the CSI report based on the M_{ν} basis vectors, wherein when N>M_{ν}, the CSI report includes an indicator indicating an information about the selected M_{ν} basis vectors; and transmitting the CSI report including the indicator indicating the information about the selected M_{ν} basis vectors when N>M_{ν}. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

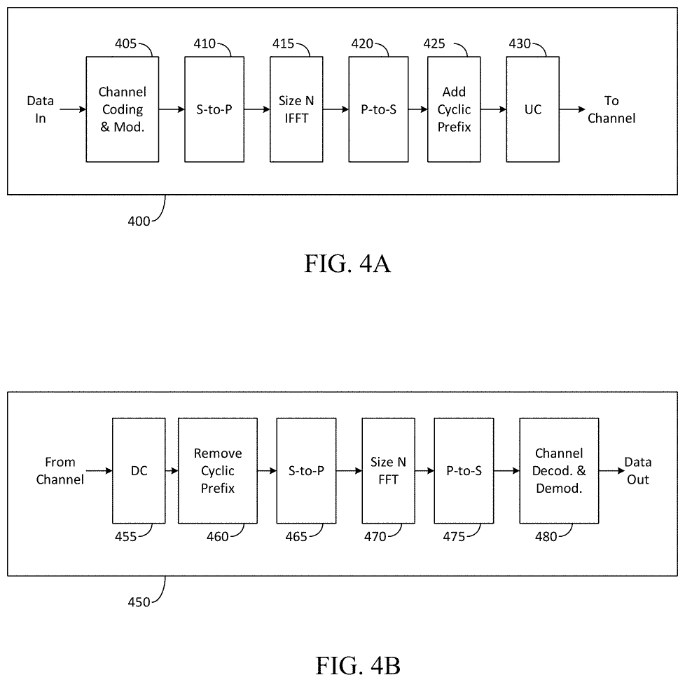

FIG. 4A is a high-level diagram of transmit path circuitry. For example, the transmit path circuitry may be used for an orthogonal frequency division multiple access (OFDMA) communication. FIG. 4B is a high-level diagram of receive path circuitry. For example, the receive path circuitry may be used for an orthogonal frequency division multiple access (OFDMA) communication. In FIGS. 4A and 4B, for downlink communication, the transmit path circuitry may be implemented in a base station (gNB) 102 or a relay station, and the receive path circuitry may be implemented in a user equipment (e.g., user equipment 116 of FIG. 1). In other examples, for uplink communication, the receive path circuitry 450 may be implemented in a base station (e.g., gNB 102 of FIG. 1) or a relay station, and the transmit path circuitry may be implemented in a user equipment (e.g., user equipment 116 of FIG. 1).

Transmit path circuitry comprises channel coding and modulation block 405, serial-to-parallel (S-to-P) block 410, Size N Inverse Fast Fourier Transform (IFFT) block 415, parallel-to-serial (P-to-S) block 420, add cyclic prefix block 425, and up-converter (UC) 430. Receive path circuitry 450 comprises down-converter (DC) 455, remove cyclic prefix block 460, serial-to-parallel (S-to-P) block 465, Size N Fast Fourier Transform (FFT) block 470, parallel-to-serial (P-to-S) block 475, and channel decoding and demodulation block 480.

At least some of the components in FIGS. 4A 400 and 4B 450 may be implemented in software, while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and may not be construed to limit the scope of the disclosure. It may be appreciated that in an alternate embodiment of the present disclosure, the Fast Fourier Transform functions and the Inverse Fast Fourier Transform functions may easily be replaced by discrete Fourier transform (DFT) functions and inverse discrete Fourier transform (IDFT) functions, respectively. It may be appreciated that for DFT and IDFT functions, the value of the N variable may be any integer number (i.e., 1, 4, 3, 4, etc.), while for FFT and IFFT functions, the value of the N variable may be any integer number that is a power of two (i.e., 1, 2, 4, 8, 16, etc.).

In transmit path circuitry 400, channel coding and modulation block 405 receives a set of information bits, applies coding (e.g., LDPC coding) and modulates (e.g., quadrature phase shift keying (QPSK) or quadrature amplitude modulation (QAM)) the input bits to produce a sequence of frequency-domain modulation symbols. Serial-to-parallel block 410 converts (i.e., de-multiplexes) the serial modulated symbols to parallel data to produce N parallel symbol streams where N is the IFFT/FFT size used in BS 102 and UE 116. Size N IFFT block 415 then performs an IFFT operation on the N parallel symbol streams to produce time-domain output signals. Parallel-to-serial block 420 converts (i.e., multiplexes) the parallel time-domain output symbols from Size N IFFT block 415 to produce a serial time-domain signal. Add cyclic prefix block 425 then inserts a cyclic prefix to the time-domain signal. Finally, up-converter 430 modulates (i.e., up-converts) the output of add cyclic prefix block 425 to RF frequency for transmission via a wireless channel. The signal may also be filtered at baseband before conversion to RF frequency.

The transmitted RF signal arrives at the UE 116 after passing through the wireless channel, and reverse operations to those at gNB 102 are performed. Down-converter 455 down-converts the received signal to baseband frequency and removes cyclic prefix block 460, and removes the cyclic prefix to produce the serial time-domain baseband signal. Serial-to-parallel block 465 converts the time-domain baseband signal to parallel time-domain signals. Size N FFT block 470 then performs an FFT algorithm to produce N parallel frequency-domain signals. Parallel-to-serial block 475 converts the parallel frequency-domain signals to a sequence of modulated data symbols. Channel decoding and demodulation block 480 demodulates and then decodes the modulated symbols to recover the original input data stream.

Each of gNBs 101-103 may implement a transmit path that is analogous to transmitting in the downlink to user equipment 111-116 and may implement a receive path that is analogous to receiving in the uplink from user equipment 111-116. Similarly, each one of user equipment 111-116 may implement a transmit path corresponding to the architecture for transmitting in the uplink to gNBs 101-103 and may implement a receive path corresponding to the architecture for receiving in the downlink from gNBs 101-103.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE system, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH).

An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{sc}^{RB} sub-carriers, or resource elements (REs), such as 12 REs. A unit of one RB over one subframe is referred to as a PRB. A UE can be allocated M_{PDSCI} RBs for a total of M_{sc}^{PDSCH}=M_{PDSCH}·N_{sc}^{RB} REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH.

An UL subframe (or slot) includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} N REs for a transmission BW. For a PUCCH, N_{RB}=1. A last subframe symbol can be used to multiplex SRS transmissions from one or more UEs. A number of subframe symbols that are available for data/UCI/DMRS transmission is N_{symb}=2·(N_{symb}^{UL}−1)−N_{SRS}, where N_{SRS}=1 if a last subframe symbol is used to transmit SRS and N_{SRS}=0 otherwise.

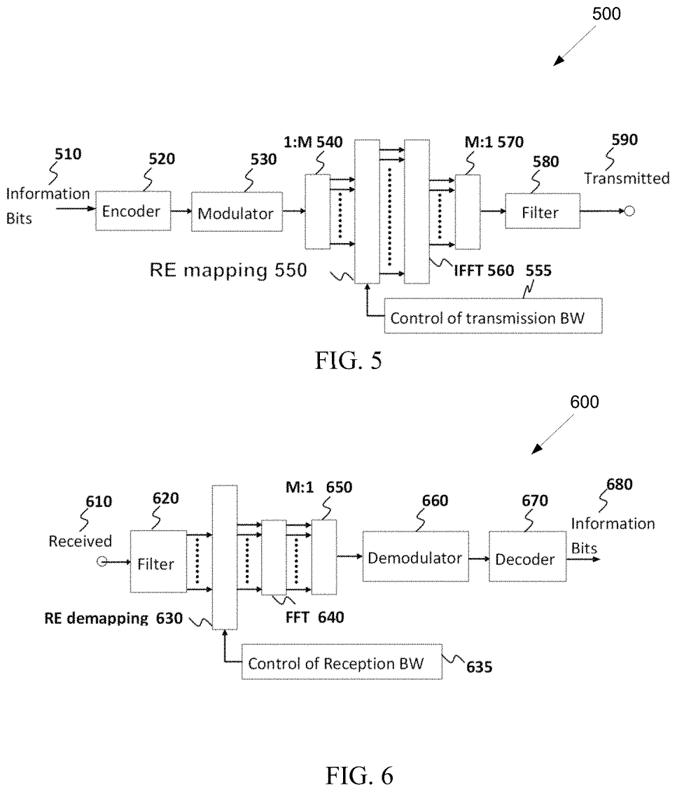

FIG. 5 illustrates a transmitter block diagram 500 for a PDSCH in a subframe according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates a receiver block diagram 600 for a PDSCH in a subframe according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

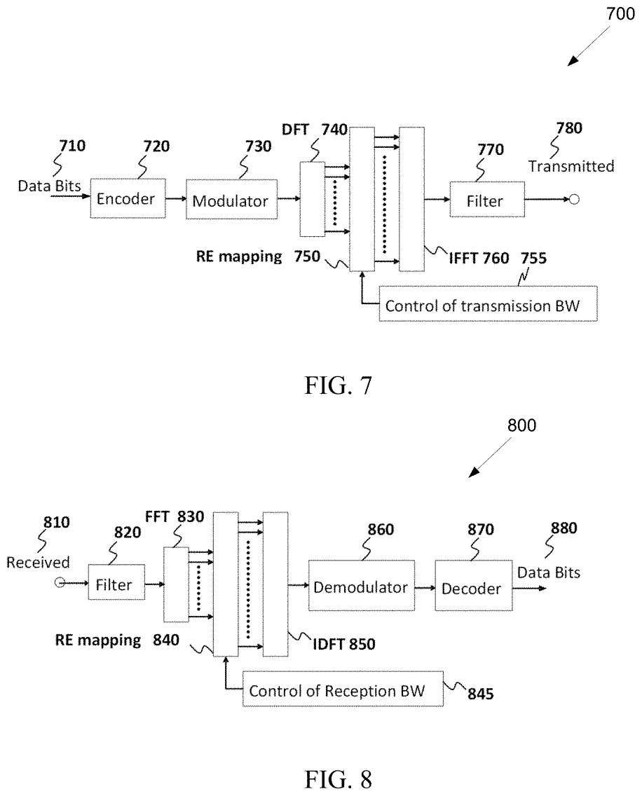

FIG. 7 illustrates a transmitter block diagram 700 for a PUSCH in a subframe according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

In next generation cellular systems, various use cases are envisioned beyond the capabilities of LTE system. Termed 5G or the fifth generation cellular system, a system capable of operating at sub-6 GHz and above-6 GHz (for example, in mmWave regime) becomes one of the requirements. In 3GPP TR 22.891, 74 5G use cases have been identified and described; those use cases can be roughly categorized into three different groups. A first group is termed “enhanced mobile broadband (eMBB),” targeted to high data rate services with less stringent latency and reliability requirements. A second group is termed “ultra-reliable and low latency (URLL)” targeted for applications with less stringent data rate requirements, but less tolerant to latency. A third group is termed “massive MTC (mMTC)” targeted for large number of low-power device connections such as 1 million per km² with less stringent the reliability, data rate, and latency requirements.

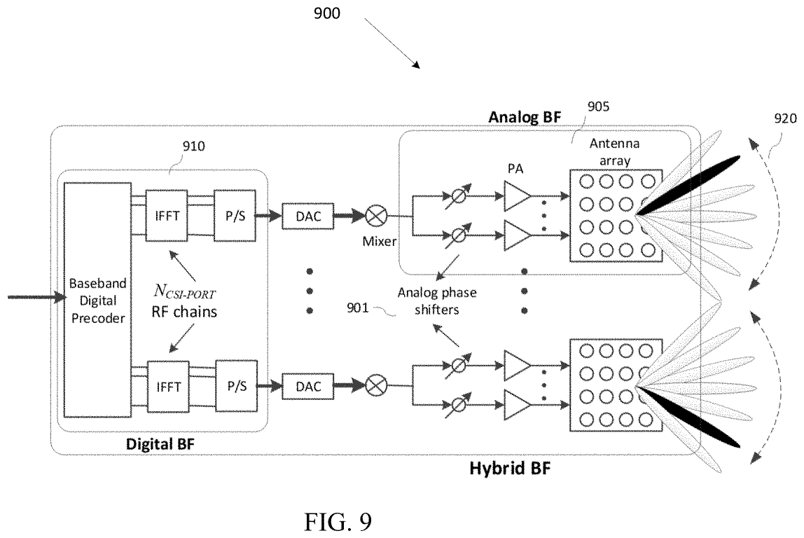

FIG. 9 illustrates an example antenna blocks or arrays 900 according to embodiments of the present disclosure. The embodiment of the antenna blocks or arrays 900 illustrated in FIG. 9 is for illustration only. FIG. 9 does not limit the scope of this disclosure to any particular implementation of the antenna blocks or arrays 900.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports NCSI-PORT. A digital beamforming unit 910 performs a linear combination across NCSI-PORT analog beams to further increase precoding gain. While analog beams are wideband (hence not frequency-selective), digital precoding can be varied across frequency sub-bands or resource blocks.

To enable digital precoding, efficient design of CSI-RS is a crucial factor. For this reason, three types of CSI reporting mechanisms corresponding to three types of CSI-RS measurement behavior are supported, for example, “CLASS A” CSI reporting which corresponds to non-precoded CSI-RS, “CLASS B” reporting with K=1 CSI-RS resource which corresponds to UE-specific beamformed CSI-RS, and “CLASS B” reporting with K>1 CSI-RS resources which corresponds to cell-specific beamformed CSI-RS.

For non-precoded (NP) CSI-RS, a cell-specific one-to-one mapping between CSI-RS port and TXRU is utilized. Different CSI-RS ports have the same wide beam width and direction and hence generally cell wide coverage. For beamformed CSI-RS, beamforming operation, either cell-specific or UE-specific, is applied on a non-zero-power (NZP) CSI-RS resource (e.g., comprising multiple ports). At least at a given time/frequency, CSI-RS ports have narrow beam widths and hence not cell wide coverage, and at least from the gNB perspective. At least some CSI-RS port-resource combinations have different beam directions.

In scenarios where DL long-term channel statistics can be measured through UL signals at a serving eNodeB, UE-specific BF CSI-RS can be readily used. This is typically feasible when UL-DL duplex distance is sufficiently small. When this condition does not hold, however, some UE feedback is necessary for the eNodeB to obtain an estimate of DL long-term channel statistics (or any of representation thereof). To facilitate such a procedure, a first BF CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For TDD systems, the CSI can be acquired using the SRS transmission relying on the channel reciprocity. For FDD systems, on the other hand, it can be acquired using the CSI-RS transmission from eNB (or gNB), and CSI acquisition and feedback from UE. In legacy FDD systems, the CSI feedback framework is ‘implicit’ in the form of CQI/PMI/RI (also CRI and LI) derived from a codebook assuming SU transmission from eNB (or gNB). Because of the inherent SU assumption while deriving CSI, this implicit CSI feedback is inadequate for MU transmission. Since future (e.g., NR) systems are likely to be more MU-centric, this SU-MU CSI mismatch will be a bottleneck in achieving high MU performance gains. Another issue with implicit feedback is the scalability with larger number of antenna ports at eNB (or gNB). For large number of antenna ports, the codebook design for implicit feedback is quite complicated (for example, a total number of 44 Class A codebooks in the 3GPP LTE specification), and the designed codebook is not guaranteed to bring justifiable performance benefits in practical deployment scenarios (for example, only a small percentage gain can be shown at the most). Realizing aforementioned issues, the 3GPP specification also supports advanced CSI reporting in LTE.

In 5G or NR systems [REF7, REF8], the above-mentioned “implicit” CSI reporting paradigm from LTE is also supported and referred to as Type I CSI reporting. In addition, a high-resolution CSI reporting, referred to as Type II CSI reporting, is also supported to provide more accurate CSI information to gNB for use cases such as high-order MU-MIMO. However, the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of

$$\frac{{P}_{CSI - RS}}{2}$$

CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

It has been known in the literature that UL-DL channel reciprocity can exist in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in W_{f} can be replaced with SD and FD port selection, i.e., L CSI-RS ports are selected in SD and/or M ports are selected in FD. The CSI-RS ports in this case are beamformed in SD (assuming UL-DL channel reciprocity in angular domain) and/or FD (assuming UL-DL channel reciprocity in delay/frequency domain), and the corresponding SD and/or FD beamforming information can be obtained at the gNB based on UL channel estimated using SRS measurements. This disclosure provides some of design components of such a codebook.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤NCSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

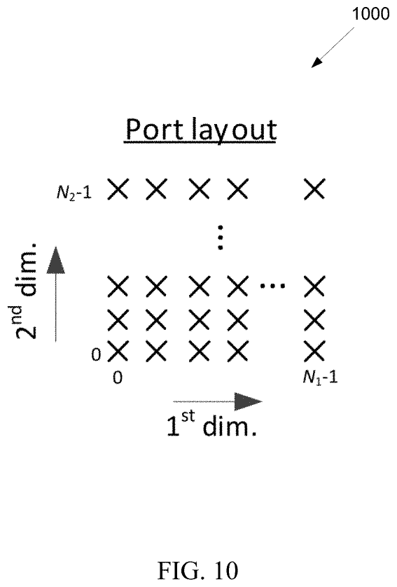

FIG. 10 illustrates an example antenna port layout 1000 according to embodiments of the present disclosure. The embodiment of the antenna port layout 1000 illustrated in FIG. 10 is for illustration only. FIG. 10 does not limit the scope of this disclosure to any particular implementation of the antenna port layout 1000.

As illustrated in FIG. 10, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂ when each antenna maps to an antenna port. An illustration is shown in FIG. 10 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-Rs antenna ports and X is a starting antenna port number (e.g., X=3000, then antenna ports are 3000, 3001, 3002, . . . ).

As described in U.S. Pat. No. 10,659,118, issued May 19, 2020 and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination based Type II CSI reporting framework is extended to include a frequency dimension in addition to the first and second antenna port dimensions.

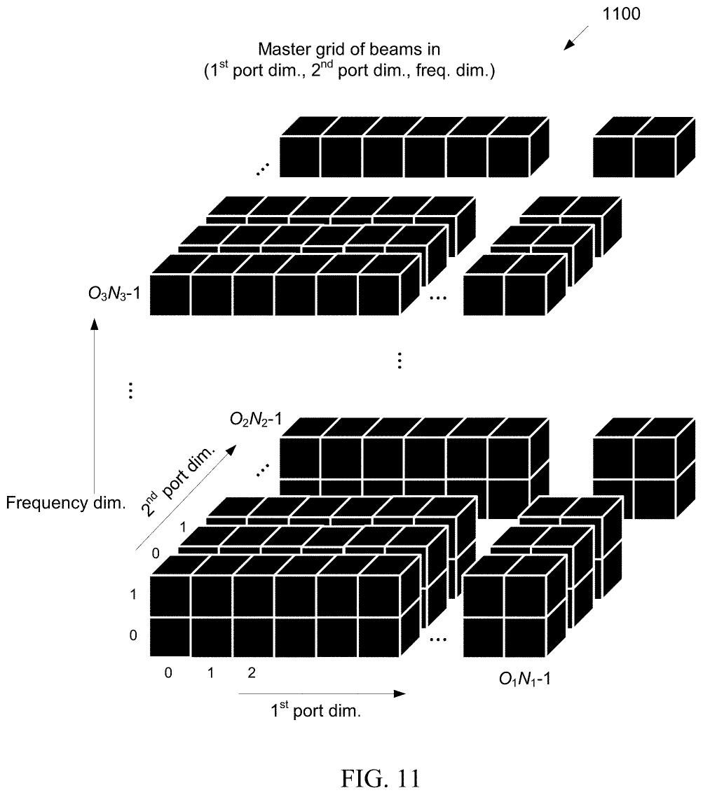

FIG. 11 illustrates a 3D grid 1100 of the oversampled DFT beams (1st port dim., 2nd port dim., freq. dim.) in which
1st dimension is associated with the 1st port dimension,
2nd dimension is associated with the 2nd port dimension, and
3rd dimension is associated with the frequency dimension.
   The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In another example, the oversampling factors Oᵢ belongs to {2, 4, 8}. In yet another example, at least one of O₁, O₂, and O₃ is higher layer configured (via RRC signaling).

As explained in Section 5.2.2.2.6 of REF8, a UE is configured with higher layer parameter codebookType set to ‘ typeII-PortSelection-r16’ for an enhanced Type II CSI reporting in which the pre-coders for all SBs and for a given layer l=1, . . . , ν, where ν is the associated RI value, is given by either

$$\begin{matrix}{W}^{l} = {AC}_{l} {B}^{H} = [ \begin{matrix}{a}_{0} & {a}_{1} & … & {a}_{L - 1}\end{matrix} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] {[ \begin{matrix}{b}_{0} & {b}_{1} & … & {b}_{M - 1}\end{matrix} ]}^{H} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) \\ & ( Eq . 1 ) \\ or & \\ {W}^{l} = [ \begin{matrix}A & 0 \\ 0 & A\end{matrix} ] {C}_{l} {B}^{H} = [ \begin{matrix}{a}_{0} {a}_{1} … {a}_{L - 1} & 0 \\ 0 & {a}_{0} {a}_{1} … {a}_{L - 1}\end{matrix} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] {[ \begin{matrix}{b}_{0} & {b}_{1} & … & {b}_{M - 1}\end{matrix} ]}^{H} = [ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] , & ( Eq . 2 )\end{matrix}$$

where
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),
aᵢ is a 2N₁N₂×1 (Eq. 1) or N₁N₂×1 (Eq. 2) column vector, and al is a N₁N₂×1 or

$$\frac{{P}_{CSIRS}}{2} \times 1$$

port selection column vector if antenna ports at the gNB are co-polarized, and is a 2N₁N₂×1 or P_{CSIRS}×1 port selection column vector if antenna ports at the gNB are dual-polarized or cross-polarized, where a port selection vector is a defined as a vector which contains a value of 1 in one element and zeros elsewhere, and P_{CSIRS} is the number of CSI-RS ports configured for CSI reporting,
b_{f} is a N₃×1 column vector,
c_{l,i,f} is a complex coefficient associated with vectors aᵢ and b_{f}.

In one example, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f} ×c_{l,i,f}, where
x_{l,i,f}=1 if the coefficient cₗif is reported by the UE according to some embodiments of this invention.
x_{l,i,f}=0 otherwise (i.e., c_{l,i,f} is not reported by the UE).
   The indication whether x_{l,i,f}=1 or 0 is according to some embodiments of this invention. For example, it can be via a bitmap.

In another example, the precoder equations Eq. 1 or Eq. 2 are respectively generalized to

$$\begin{matrix}{W}^{l} = {\sum }_{i = 0}^{L - 1} {\sum }_{f = 0}^{{M}_{i} - 1} {c}_{l , i , f} ( {a}_{i} {b}_{i , f}^{H} ) & ( Eq . 3 ) \\ and & \\ {w}^{l} = [ \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{f = 0}^{{M}_{i} - 1} {c}_{l , i + L , f} ( {a}_{i} {b}_{i , f}^{H} )\end{matrix} ] , & ( Eq . 4 )\end{matrix}$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or ΣMᵢ is either fixed, configured by the gNB or reported by the UE).

The columns of W^{l} are normalized to norm one. For rank R or R layers (ν=R), the pre-coding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=w_{f}, where the quantity w_{f} is given by

$${w}_{f} = {[ \begin{matrix}1 & {e}^{j \frac{2 π {n}_{3 , l}^{( f )}}{{O}_{3} {N}_{3}}} & {e}^{j \frac{2 π \cdot 2 {n}_{3 , l}^{( f )}}{{O}_{3} {N}_{3}}} & … & {e}^{j \frac{2 π \cdot ( {N}_{3} - 1 ) {n}_{3 , l}^{( f )}}{{O}_{3} {N}_{3}}}\end{matrix} ]}^{T} .$$

When O₃=1, the FD basis vector for layer l ∈{1, . . . , ν} (where ν is the RI or rank value) is given by

$${w}_{f} = {[ \begin{matrix}{y}_{0 , l}^{( f )} & {y}_{1 , l}^{( f )} & … & {y}_{{N}_{3} - 1 , l}^{( f )}\end{matrix} ]}^{T} , where {y}_{t , l}^{( f )} = {e}^{j \frac{2 π t {n}_{3 , l}^{( f )}}{{N}_{3}}} and {n}_{3 , l} = [ {n}_{3 , l}^{( 0 )} , … , {n}_{3 , l}^{( M - 1 )} ] where {n}_{3 , l}^{( 0 )} ∈ \{ 0 , 1 , … , {N}_{3} - 1 \} . \qquad$$

In another example, discrete cosine transform DCT basis is used to construct/report basis B for the 3^{rd} dimension. The m-th column of the DCT compression matrix is simply given by

$$[ {W}_{f} ] = \{ \begin{matrix}\frac{1}{\sqrt{K}} , & n = 0 \\ \sqrt{\frac{2}{K} cos \frac{π ( 2 m + 1 ) n}{2 K} ,} & n = 1 , … K - 1\end{matrix} ,$$

and K=N₃, and m=0, . . . , N₃−1.

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows.

W=AₗCₗBₗ^{H}=W₁\tilde{W}₂W_{f}^{H}, (equation 5)

where A=W₁ corresponds to the Rel. 15 W₁ in Type II CSI codebook [REF8], and B=W_{f}.

The C=\tilde{W}₂ matrix consists of all the required linear combination coefficients (e.g., amplitude and phase or real or imaginary). Each reported coefficient (c_{l,i,f}=p_{l,i,f}ϕ_{l,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as p_{l,i,f}=p_{l,i,f}⁽¹⁾p_{l,i,f}⁽²⁾ where
p_{l,i,f}⁽¹⁾ is a reference or first amplitude which is reported using a A1-bit amplitude codebook where A1 belongs to {2, 3, 4}, and
p_{l,i,f}⁽²⁾ is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f*}. The strongest coefficient is reported out of the K_{N}Z non-zero (NZ) coefficients that is reported using a bitmap, where K_{NZ}≤K₀=┌β×2LM┐<2LM and β is higher layer configured. The remaining 2LM−K_{NZ} coefficients that are not reported by the UE are assumed to be zero. The following quantization scheme is used to quantize/report the K_{NZ} NZ coefficients.

The UE reports the following for the quantization of the NZ coefficients in \tilde{W}₂
A X-bit indicator for the strongest coefficient index (i*,f*) where X=┌log₂ K_{NZ}┐ or ┌log₂ 2L┐.
   Strongest coefficient c_{l,i*,f*}=1 (hence its amplitude/phase are not reported)
Two antenna polarization-specific reference amplitudes is used.
   For the polarization associated with the strongest coefficient c_{l,i*,f*}=1, since the reference amplitude p_{l,i,f}⁽¹⁾=1, it is not reported
   For the other polarization, reference amplitude p_{l,i,f}⁽¹⁾ is quantized to 4 bits
      The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

For {c_{l,i,f}, (i, f)≠(i*, f*)}:
   For each polarization, differential amplitudes p_{l,i,f}⁽²⁾ of the coefficients calculated relative to the associated polarization-specific reference amplitude and quantized to 3 bits
      The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

Note: The final quantized amplitude p_{l,i,f} is given by p_{l,i,f}⁽¹⁾×p_{l,i,f}⁽²⁾
Each phase is quantized to either 8 PSK (Nₚₕ=8) or 16 PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude p_{l,i,f}⁽¹⁾=p_{l,r*}⁽¹⁾=1. For the other polarization r∈{0,1} and r≠r*, we have

$$r = ( ⌊ \frac{{i}^{*}}{L} ⌋ + 1 )$$

mod 2 and the reference amplitude p_{l,i,f}⁽¹⁾=p_{l,r}⁽¹⁾ is quantized (reported) using the 4-bit amplitude codebook mentioned above.

A UE can be configured to report M FD basis vectors. In one example, M=

$$⌈ p \times \frac{{N}_{3}}{R} ⌉ ,$$

where R is higher-layer configured from {1,2} and p is higher-layer configured from {¼, ½}. In one example, the p value is higher-layer configured for rank 1-2 CSI reporting. For rank>2 (e.g., rank 3-4), the p value (denoted by ν₀) can be different. In one example, for rank 1-4, (p, ν₀) is jointly configured from {(½, ¼), (¼, ¼), (¼, ¼)}, i.e.,

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting.

A UE can be configured to report M FD basis vectors in one-step from N₃ basis vectors freely (independently) for each layer l∈{0, 1, . . . , ν−1} of a rank ν CSI reporting. Alternatively, a UE can be configured to report M FD basis vectors in two-step as follows.
In step 1, an intermediate set (InS) comprising N′₃<N₃ basis vectors is selected/reported, wherein the InS is common for all layers.
In step 2, for each layer l∈{0, 1, . . . , ν−1} of a rank ν CSI reporting, M FD basis vectors are selected/reported freely (independently) from N′₃ basis vectors in the InS.

In one example, one-step method is used when N₃≤19 and two-step method is used when N₃>19. In one example, N′₃=┌αM┐ where α>1 is either fixed (to 2 for example) or configurable.

The codebook parameters used in the DFT based frequency domain compression (eq. 5) are (L, p, ν₀, β, α, Nₚₕ). In one example, the set of values for these codebook parameters are as follows.
L: the set of values is {2,4} in general, except L∈{2,4,6} for rank 1-2, 32 CSI-RS antenna ports, and R=1.
p for rank 1-2, and (p, ν₀) for rank 3-4: p∈{¼, ½} and (p, ν₀)∈{(½, ¼), (¼, ¼), (¼, ⅛)}.
β∈{¼, ½, ¾}.
α∈{1.5,2,2.5,3}
Nₚₕ∈{8,16}.

In another example, the set of values for the codebook parameters (L, p, ν₀, β, α, Nₚₕ) are as follows: α=2, Nₚₕ=16, and as in Table 1, where the values of L,β and p_{ν} are determined by the higher layer parameter paramCombination-r17. In one example, the UE is not expected to be configured with paramCombination-r17 equal to
3, 4, 5, 6, 7, or 8 when PCSI-RS 4,
7 or 8 when number of CSI-RS ports P_{CSI-RS}<32,
7 or 8 when higher layer parameter typeII-RI-Restriction-r17 is configured with rt=1 for any i>1,
7or 8 when R=2.

The bitmap parameter typeII-RI-Restriction-r17 forms the bit sequence r₃, r₂, r₁, r₀ where r₀ is the LSB and r₃ is the MSB. When rᵢ is zero, i∈{0,1, . . . ,3}, PMI and RI reporting are not allowed to correspond to any precoder associated with ν=i+1 layers. The parameter R is configured with the higher-layer parameter numberOfPMISubbandsPerCQISubband-r17. This parameter controls the total number of precoding matrices N₃ indicated by the PMI as a function of the number of subbands in csi-ReportingBand, the subband size configured by the higher-level parameter subbandSize and of the total number of PRBs in the bandwidth part.

TABLE 1

pᵥ

| paramCombination-r17 | L | v ∈ {1, 2} | v ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The above-mentioned framework (equation 5) represents the precoding-matrices for multiple (N₃) FD units using a linear combination (double sum) over 2L SD beams and M_{ν} FD beams. This framework can also be used to represent the precoding-matrices in time domain (TD) by replacing the FD basis matrix W_{f} with a TD basis matrix Wₜ, wherein the columns of Wₜ comprises M_{ν} TD beams that represent some form of delays or channel tap locations. Hence, a precoder W^{l} can be described as follows.

W=AₗCₗBₗ^{H}=W₁\tilde{W}₂Wₜ^{H}, (equation 5A)

In one example, the M_{ν} TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

This disclosure is applicable to both space-frequency (equation 5) and space-time (equation 5A) frameworks.

In general, for layer l=0, 1, . . . , ν−1, where ν is the rank value reported via RI, the pre-coder (cf. equation 5 and equation 5A) includes the codebook components summarized in Table 2.

TABLE 2
Codebook Components

| Index | Components | Description |
|---|---|---|
| 0 | L | number of SD beams |
| 1 | Mᵥ | number of FD/TD beams |
| 2 | {aᵢ}ᵢ₌₀^{L-1} | set of SD beams comprising columns of Aₗ |
| 3 | {b_{l, f}}_{f=0}^{M}^{ᵥ}⁻¹ | set of FD/TD beams comprising columns of Bₗ |
| 4 | {x_{l, i, f}} | bitmap indicating the indices of the non-zero |
| | | (NZ) coefficients |
| 5 | SCIₗ | Strongest coefficient indicator for layer l |
| 6 | {p_{l, i, f}} | amplitudes of NZ coefficients indicated via the |
| | | bitmap |
| 7 | {ϕ_{l, i, f}} | phases of NZ coefficients indicated via the |
| | | bitmap |

Let P_{CSIRS,SD} and P_{CSIRS,FD} be number of CSI-RS ports in SD and FD, respectively. The total number of CSI-RS ports is P_{CSIRS,SD}×P_{CSIRS,FD}=P_{CSIRS}. Each CSI-RS port can be beam-formed/pre-coded using a pre-coding/beam-forming vector in SD or FD or both SD and FD. The pre-coding/beam-forming vector for each CSI-RS port can be derived based on UL channel estimation via SRS, assuming (partial) reciprocity between DL and UL channels. Since CSI-RS ports can be beam-formed in SD as well as FD, the Rel. 15/16 Type II port selection codebook can be extended to perform port selection in both SD and FD followed by linear combination of the selected ports. In the rest of the disclosure, some details pertaining to the port selection codebook for this extension are provided.

In this disclosure, the terms ‘beam’ and ‘port’ are used interchangeably and they refer to the same component of the codebook. For brevity, beam/port or port/beam is used in this disclosure.

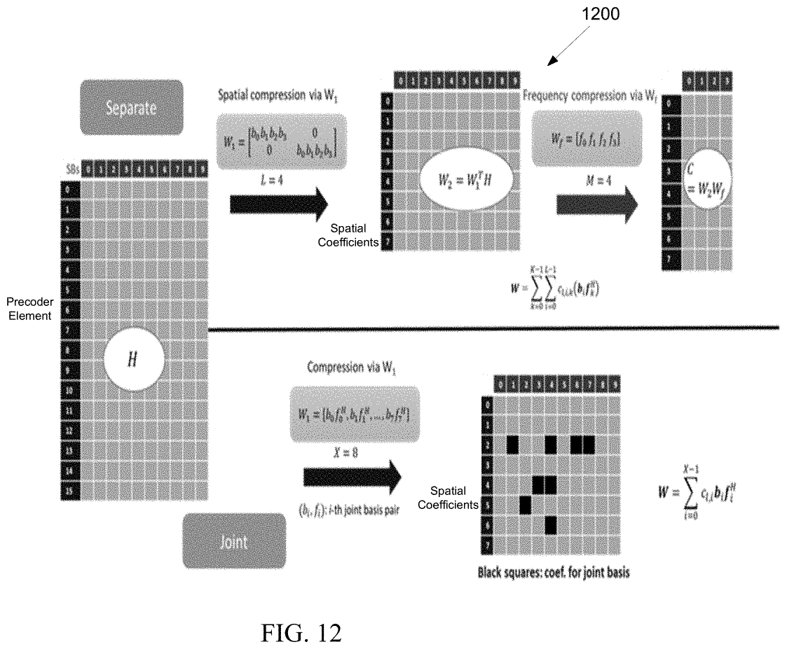

FIG. 12 illustrates an example of a new port selection codebook that facilitates independent (separate) port selection across SD and FD, and that also facilitates joint port selection across SD and FD 1200 according to embodiments of the disclosure. The embodiment of a new port selection codebook that facilitates independent (separate) port selection across SD and FD, and that also facilitates joint port selection across SD and FD 1200 illustrated in FIG. 12 is for illustration only. FIG. 12 does not limit the scope of this disclosure to any particular implementation of the example of a new port selection codebook that facilitates independent (separate) port selection across SD and FD, and that also facilitates joint port selection across SD and FD 1200.

In one embodiment (A.1), a UE is configured with higher layer parameter codebookType set to ‘typeII-r17’ or ‘typeII-PortSelection-r17’ for CSI reporting based on a new (Rel. 17) Type II port selection codebook in which the port selection (which is in SD) in Rel. 15/16 Type II port selection codebook is extended to FD in addition to SD. The UE is also configured with P_{CSIRS} CSI-RS ports (either in one CSI-RS resource or distributed across more than one CSI-RS resources) linked with the CSI reporting based on this new Type II port selection codebook. In one example, P_{CSIRS}=Q. In another example, P_{CSIRS}≥Q. Here, Q=P_{CSIRS,SD}×P_{CSIRS,FD}. The CSI-RS ports can be beamformed in SD and/or FD. The UE measures P_{CSIRS} (or at least Q) CSI-RS ports, estimates (beam-formed) DL channel, and determines a precoding matrix indicator (PMI) using the new port selection codebook, wherein the PMI indicates a set of components S that can be used at the gNB to construct precoding matrices for each FD unit t∈{0, 1, . . . , N₃−1}(together with the beamforming used to beamformed CSI-RS). In one example, P_{CSIRS,SD} ∈{4,8,12,16,32} or {2,4,8,12,16,32}. In one example, P_{CSIRS,SD} and P_{CSIRS,FD} are such that their product Q=P_{CSIRS,SD}×P_{CSIRS,FD} ∈{4,8,12,16,32} or {2,4,8,12,16,32}.

The new port selection codebook facilitates independent (separate) port selection across SD and FD. This is illustrated in top part of FIG. 12.

For layer l=1, . . . , ν, where ν is the rank value reported via RI, the pre-coder (cf. equation 5 and equation 5A) includes the codebook components (indicated via PMI) summarized in Table 3. The parameters L and Mᵢ are either fixed or configured (e.g., via RRC).

TABLE 3
Codebook components

| Index | Components | Description |
|---|---|---|
| 0 | {aᵢ}ᵢ₌₀^{L-1} | set of SD beams/ports comprising columns of Aₗ |
| 1 | {b_{l, f}}_{f=0}^{M}^{ᵥ}⁻¹ | set of FD/TD beams/ports comprising columns of Bₗ |
| 2 | {x_{l, i, f}} | bitmap indicating the indices of the non-zero |
| | | (NZ) coefficients |
| 3 | SCIₗ | an indicator indicating an index (iₗ*, fₗ*)of the |
| | | strongest coefficient for layer l |
| 4 | p_{l, r}⁽¹⁾ | reference amplitude |
| 5 | {p_{l, i, f}} | amplitudes of NZ coefficients indicated via the |
| | | bitmap |
| 6 | {ϕ_{l, i, f}} | phases of NZ coefficients indicated via the |
| | | bitmap |

In one embodiment (A.2), a UE is configured with higher layer parameter codebookType set to ‘typeII-r17’ or ‘typeII-PortSelection-r17’ for CSI reporting based on a new (Rel. 17) Type II port selection codebook in which the port selection (which is in SD) in Rel. 15/16 Type II port selection codebook is extended to FD in addition to SD. The UE is also configured with P_{CSIRS} CSI-RS ports (either in one CSI-RS resource or distributed across more than one CSI-RS resources) linked with the CSI reporting based on this new Type II port selection codebook. In one example, P_{CSIRS}=Q. In another example, P_{CSIRS}≥Q. Here, Q=P_{CSIRS,SD}×P_{CSIRS,FD}. The CSI-RS ports can be beamformed in SD and/or FD. The UE measures P_{CSIRS} (or at least Q) CSI-RS ports, estimates (beam-formed) DL channel, and determines a precoding matrix indicator (PMI) using the new port selection codebook, wherein the PMI indicates a set of components S that can be used at the gNB to construct precoding matrices for each FD unit t∈{0, 1, . . . , N₃−1}(together with the beamforming used to beamformed CSI-RS). In one example, P_{CSIRS,SD} ∈{4,8,12,16,24,32} or {2,4,8,12,16,24,32}. In one example, P_{CSIRS,SD} and P_{CSIRS,FD} are such that their product Q=P_{CSIRS,SD}×P_{CSIRS,FD} ∈{4,8,12,16,24,32} or {2,4,8,12,16,24,32}.

The new port selection codebook facilitates joint port selection across SD and FD. This is illustrated in bottom part of FIG. 8. The codebook structure is similar to Rel. 15 NR Type II codebook comprising two main components.
W₁: to select Y_{ν} out of P_{CSI-RS} SD-FD port pairs jointly
   In one example, Y_{ν} ≤P_{CSI-RS} (if the port selection is independent across two polarizations or two groups of antennas with different polarizations)
   In one example,

$${Y}_{υ} \leq \frac{{P}_{CSI - RS}}{2}$$

(if the port selection is common across two polarizations or two groups of antennas with different polarizations)
W₂: to select coefficients for the selected Y_{ν} SD-FD port pairs.

In one example, the joint port selection (and its reporting) is common across multiple layers (when ν>1). In one example, the joint port selection (and its reporting) is independent across multiple layers (when ν>1). The reporting of the selected coefficients is independent across multiple layers (when ν>1).

For layer l=1, . . . , ν, where ν is the rank value reported via RI, the pre-coder (cf. equation 5 and equation 5A) includes the codebook components (indicated via PMI) summarized in Table 4. The parameter Y_{ν} is either fixed or configured (e.g., via RRC).

TABLE 4
Codebook Components

| Index | Components | Description |
|---|---|---|
| 0 | {(a_{l, i}, | set of selected (SD, FD/TD) beam/port pairs |
| | b_{l, i})}ᵢ₌₀^{Y}^{ᵥ}⁻¹ | comprising columns of Aₗ and Bₗ |
| 1 | {x_{l, i}} | bitmap indicating the indices of the non-zero |
| | | (NZ) coefficients |
| 2 | SCIₗ | an indicator indicating an index iₗ* of the |
| | | strongest coefficient for layer l |
| 3 | p_{l, r}⁽¹⁾ | reference amplitude |
| 4 | {p_{l, i}} | amplitudes of NZ coefficients indicated via the |
| | | bitmap |
| 5 | {ϕ_{l, i}} | phases of NZ coefficients indicated via the |
| | | bitmap |

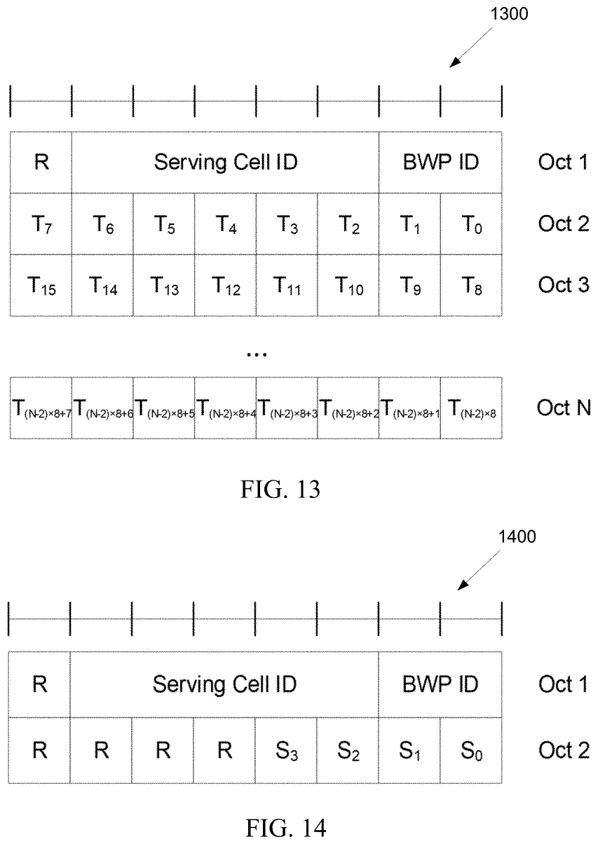

FIG. 13 illustrates an example aperiodic CSI trigger state sub-selection MAC CE 1300 according to embodiments of the present disclosure. The embodiment of the example aperiodic CSI trigger state sub-selection MAC CE 1300 illustrated in FIG. 13 is for illustration only. FIG. 13 does not limit the scope of this disclosure to any particular implementation of the example aperiodic CSI trigger state sub-selection MAC CE 1300.

FIG. 14 illustrates an example SP CSI reporting on PUCCH activation/deactivation MAC CE 1400 according to embodiments of the present disclosure. The embodiment of the example SP CSI reporting on PUCCH activation/deactivation MAC CE 1400 illustrated in FIG. 14 is for illustration only. FIG. 14 does not limit the scope of this disclosure to any particular implementation of the example SP CSI reporting on PUCCH activation/deactivation MAC CE 1400.

In one embodiment (I.1), the PMI codebook components (e.g., as in Table 2/Table 3/Table 4) can be divided into two subsets, a first subset (S1) and a second subset (S2), and a UE is configured (or activated or indicated) with a first subset (S1) of PMI codebook components. The UE uses the first subset (S1) of PMI codebook components to derive the second subset (S2) of codebook components. In one example, the first subset (S1) of PMI codebook components is derived (e.g., by the gNB) based on the UL channel estimated using SRS transmission from the UE, and the derived first subset (S1) is configured (or activated or indicated) to the UE. The first and second subsets may be disjoint, i.e., they do not have any common codebook components. Alternatively, they may have at least one common codebook component. In one example, the first subset (S1) is according to one of the examples in embodiment 1.2 of this disclosure.

At least one of the following examples is used for the configuration (or activation or indication) of the first subset (S1) of PMI codebook components.

In one example (I.1.1), the first subset (S1) of PMI codebook components is configured via higher layer RRC signaling. At least one of the following examples is used/configured.
In one example (I.1.1.1), this configuration is joint with another RRC parameter. For example, it can be jointly with paramCombination-r16 or paramCombination-r17 that configures the values for L, M_{ν}, and β. Alternatively, it can be jointly with a codebook subset restriction (CBSR) parameter n1-n2-codebookSubsetRestriction-r16 or n1-n2-codebookSubsetRestriction-r17 that configures the value of N₁ and N₂. Alternatively, it can be jointly with a codebook subset restriction parameter typeII-PortSelectionRI-Restriction-r16 or typeII-PortSelectionRI-Restriction-r17 that configures the allowed rank values. Alternatively, it can be jointly with a parameter nrofPorts that configures a number of CSI-RS ports.
In one example (I.1.1.2), this configuration is separate via a new (dedicated) RRC parameter. For example, it can be via a new CBSR parameter, e.g., basisRestriction-r17. Alternatively, it can be via a new RRC parameter, e.g., typeII-Basis-r17.

In one example (I.1.2), the first subset (S1) of PMI codebook components is activated via a MAC CE activation command. In one example, whether there is such an activation can be configured via higher layer RRC signaling. In another example, the MAC CE activation activates a first subset (S1) from multiple candidates for the first subset (S1) and the multiple candidates are configured via RRC signaling. At least one of the following examples is used/configured for the MAC CE activation.
In one example (I.1.2.1), this activation is joint with another MAC CE activation command. For example, it is joint with the Aperiodic CSI Trigger State Subselection MAC CE as illustrated in FIG. 13, e.g., either via aperiodicTriggerStateList or the reserved bit R. Alternatively, it is joint with the SP CSI reporting on PUCCH Activation/Deactivation MAC CE as illustrated in FIG. 14, e.g., either via one of multiple of fields Sᵢ or one of multiple of reserved bits R.
In one example (I.1.2.2), this activation is separate via a new (dedicated) MAC CE activation command.

In one example (I.1.3), the first subset (S1) of PMI codebook components is indicated/triggered via a L1-control (DCI) signaling. In one example, whether there is such an indication can be configured/activated via higher layer RRC or MAC CE signaling. In another example, the DCI signaling indicates a first subset (S1) from multiple candidates for the first subset (S1) and the multiple candidates are configured/configured via RRC and/or MAC CE signaling. At least one of the following examples is used/configured for the DCI based indication/triggering.
In one example (I.1.3.1), this indication/triggering is joint with code points of another DCI field. For example, it can be joint with the DCI field ‘CSI request’ that triggers an aperiodic CSI reporting.
In one example (I.1.3.2), this indication/triggering is separate via code points of a new (dedicated) DCI field.

In one example (I.1.4), the first subset (S1) of PMI codebook components is configured/activated via a combination of higher layer RRC signaling and MAC CE activation. At least one of the following examples is used/configured for the DCI based indication/triggering.
In one example (I.1.4.1), S1 is partitioned into two subsets S11 and S12. The RRC signaling configures a subset (S11) of the first subset (S1), and the MAC CE activation activates another subset (S12) of the first subset (S1). The details of RRC configuration are according to example (I.1.1), and the details of MAC CE activation are according to example (I.1).
In one example (I.1.4.2), the RRC signaling configures multiple candidates for the first subset (S1), and the MAC CE activation activates one from the multiple candidates. The details of RRC configuration are according to example (I.1.1), and the details of MAC CE activation are according to example I.1.2.

In one example (I.1.5), the first subset (S1) of PMI codebook components is configured/indicated via a combination of higher layer RRC signaling and L1-control (DCI) signaling. At least one of the following examples is used/configured for the DCI based indication/triggering.
In one example (I.1.5.1), S1 is partitioned into two subsets S11 and S12. The RRC signaling configures a subset (S11) of the first subset (S1), and the DCI signaling indicates another subset (S12) of the first subset (S1). The details of RRC configuration are according to example (I.1.1), and the details of DCI signaling are according to example (I.1.3).
In one example (I.1.5.2), the RRC signaling configures multiple candidates for the first subset (S1), and the DCI signaling indicates one from the multiple candidates. The details of RRC configuration are according to example (I.1.1), and the details of DCI signaling are according to example (I.1.3).

In one example (I.1.6), the first subset (S1) of PMI codebook components is activated/indicated via a combination of MAC CE activation and L1-control (DCI) signaling. At least one of the following examples is used/configured for the DCI based indication/triggering.
In one example (I.1.6.1), S1 is partitioned into two subsets S11 and S12. The MAC CE activation activates a subset (S11) of the first subset (S1), and the DCI signaling indicates another subset (S12) of the first subset (S1). The details of MAC CE activation are according to example (I.1.2), and the details of DCI signaling are according to example (I.1.3).
In one example (I.1.6.2), the MAC CE activation activates multiple candidates for the first subset (S1), and the DCI signaling indicates one from the multiple candidates. The details of MAC CE activation are according to example (I.1.2), and the details of DCI signaling are according to example (I.1.3).

In one example (I.1.7), the first subset (S1) of PMI codebook components is configured/activated/indicated via a combination of higher layer RRC signaling, MAC CE activation, and L1-control (DCI) signaling. At least one of the following examples is used/configured for the DCI based indication/triggering.
In one example (I.1.7.1), S1 is partitioned into three subsets S11, S12, and S13. The RRC signaling configures a subset (S11) of the first subset (S1), the MAC CE activation activates another subset (S12) of the first subset (S1), and the DCI signaling indicates another subset (S13) of the first subset (S1). The details of RRC configuration are according to example (I.1.1), the details of MAC CE activation are according to example (I.1.2), and the details of DCI signaling are according to example (I.1.3).
In one example (I.1.7.2), the RRC signaling configures multiple candidates for the first subset (S1), the MAC CE activation activates a subset of the multiple candidates for the first subset (S1), and the DCI signaling indicates one from the activated subset of the multiple candidates. The details of RRC configuration are according to example I.1.1, the details of MAC CE activation are according to example (I.1.2), and the details of DCI signaling are according to example (I.1.3).

In one example (I.1.8), the first subset (S1) of PMI codebook components is fixed. In one example, the first subset (S1) is according to one of the examples in embodiment 1.2 of this disclosure.

In one embodiment (1.2), the first subset (S1) of PMI codebook components is according to at least one of the following examples. One of the following examples can be fixed, or can be configured (e.g., via RRC, or MACCE or DCI based signaling).

In one example (I.2.1), the first subset (S1) of components includes M_{ν} FD basis vectors. In one example, the M_{ν} FD basis vectors comprise columns of the basis matrix W_{f} (cf. equation 5). At least one of the following examples is used/configured. In one example, the M_{ν} FD basis vectors belong to the set of orthogonal DFT vectors {b_{f}: f=0,1, . . . , N₃−1} where

$${b}_{f} - {\frac{1}{x} [ {e}^{f \frac{j 2 π 0}{{N}_{3}}} , {e}^{f \frac{j 2 π 1}{{N}_{3}}} , … , {e}^{f \frac{j 2 π ( {N}_{3} - 1 )}{{N}_{3}}} ]}^{T}$$

and x is a normalized factor, e.g., x=1 or \sqrt{N₃}.

In one example, the first subset (S1) of components includes N FD basis vectors, where N≥M_{ν}. When N=M_{ν}, the UE uses the configured set to obtain/construct W_{f} component of the codebook. When N>M_{ν}, then the UE selects M_{ν} basis vectors from the configured set to obtain/construct W_{f} component of the codebook, and in this case, the UE reports this selection as part of the CSI reporting. When rank (number of layers)>1, then this selection can be per layer basis, i.e., for each layer l, the UE selects or reports a set of M_{ν} basis vectors from the configured set to obtain/construct W_{f} for that layer. Alternatively, when rank (number of layers)>1, then this selection can be layer-common, i.e., the UE selects or reports a set of M_{ν} basis vectors from the configured set to obtain/construct W_{f} and the selected set is common (i.e., only one set is selected) for all layers.

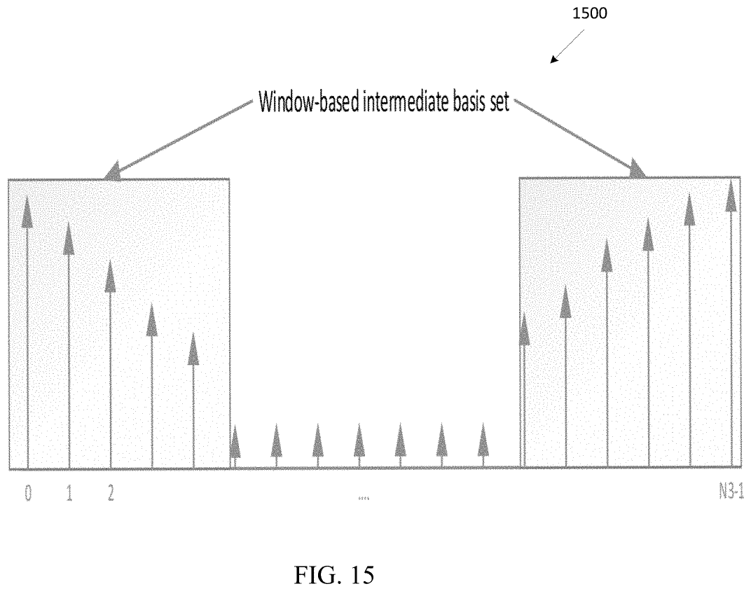

FIG. 15 illustrates an example illustration of a window-based intermediate basis set 1500 according to embodiments of the present disclosure. The embodiment of the example illustration of a window-based intermediate basis set 1500 illustrated in FIG. 15 is for illustration only. FIG. 15 does not limit the scope of this disclosure to any particular implementation of the example illustration of a window-based intermediate basis set 1500.

In one example (1.2.1.1) as illustrated in FIG. 15, the M_{ν} FD basis vectors (included in the first subset S1) are DFT vectors, each length N₃×1, and they belong to a set which can be parametrized as a window. For example, the indices of the FD basis vectors in the set are given by mod(Mᵢₙᵢₜᵢₐₗ+n, N₃), n=0, 1, . . . , N−1, which correspond to a window-based basis set comprising N≥M_{ν} adjacent FD indices with modulo-shift by N₃, where Mᵢₙᵢₜᵢₐₗ is the starting index of the basis set. Note that the window-based basis set/matrix W_{f} is completely parameterized by Mᵢₙᵢₜᵢₐₗ and N. At least one of the following examples can be used/configured to determine W_{f}.
Both Mᵢₙᵢₜᵢₐₗ and N are fixed.
Both Mᵢₙᵢₜᵢₐₗ and N are configured to the UE (via RRC and/or MAC CE and/or DCI).
Both Mᵢₙᵢₜᵢₐₗ and N are reported by the UE.
Mᵢₙᵢₜᵢₐₗ is fixed and N is configured to the UE (via RRC and/or MAC CE and/or DCI).
Mᵢₙᵢₜᵢₐₗ is fixed and N is reported by the UE.
Mᵢₙᵢₜᵢₐₗ is configured to the UE (via RRC and/or MAC CE and/or DCI) and N is fixed.
Mᵢₙᵢₜᵢₐₗ is configured to the UE (via RRC and/or MAC CE and/or DCI) and N is reported by the UE.
Mᵢₙᵢₜᵢₐₗ is reported by the UE and N is fixed.
Mᵢₙᵢₜᵢₐₗ is reported by the UE and N is configured to the UE (via RRC and/or MAC CE and/or DCI).

In one example, when Mᵢₙᵢₜᵢₐₗ is fixed, it can be fixed, for example, to Mᵢₙᵢₜᵢₐₗ=0 or Mᵢₙᵢₜᵢₐₗ=N₃−x where

$$x = \frac{N}{2} or ⌈ \frac{N}{2} ⌉ or ⌊ \frac{N}{2} ⌋ .$$

Here, the notation ┌z┐ and └z┘ denote the ceiling and the flooring functions, respectively. In one example, when Mᵢₙᵢₜᵢₐₗ is reported or configured, it is reported or indicated via an indicator iᵢₙᵢₜᵢₐₗ, which is given by

$${i}_{initial} = \{ \begin{matrix}{M}_{initial} & {M}_{initial} = 0 \\ {M}_{initial} + N & {M}_{initial} < 0\end{matrix}$$

In one example, N=M_{ν}. In one example, N=aM_{ν} where a is fixed, e.g., a=2. In one example, N is configured.

In one example (I.2.1.2), the M_{ν} FD basis vectors (included in the first subset S1) are DFT vectors, each length N₃×1, and they can be any of the N₃ DFT basis vectors. In an example, the first subset (S1) includes N FD basis vectors that are DFT vectors, each length N₃×1, and the N FD basis vectors can be any of the N₃ DFT basis vectors. Here N≥M_{ν}.

In one example (I.2.1.2A), the first subset (S1) is according to example (I.2.1.1) (window-based) or example (I.2.1.2) (free selection) based on a condition. The condition is according to at least one of the following examples.
In one example, the first subset (S1) is according to example (I.2.1.1) (window-based) when N₃>t and is according to example (I.2.1.2) (free selection) when N₃≤t.
In one example, the first subset (S1) is according to example (I.2.1.1) (window-based) when N₃≥t and is according to example (I.2.1.2) (free selection) when N₃<t.
In one example, the first subset (S1) is according to example (I.2.1.1) (window-based) when N₃<t and is according to example (I.2.1.2) (free selection) when N₃≥t.
In one example, the first subset (S1) is according to example (I.2.1.1) (window-based) when N₃<t and is according to example (I.2.1.2) (free selection) when N₃>t.
   Here, where t is a threshold that can be fixed (e.g., t=19) or configured or reported by the UE

In one example (I.2.1.2B), the first subset (S1) is according to example (I.2.1.1) (window-based) or example (I.2.1.2) (free selection) based on a condition. The condition is according to at least one of the following examples.
In one example, the first subset (S1) is according to example (I.2.1.1) (window-based) when P_{CSIRS}>p and is according to example (I.2.1.2) (free selection) when P_{CSIRS}≤p.
In one example, the first subset (S1) is according to example (I.2.1.1) (window-based) when P_{CSIRS}≥p and is according to example (I.2.1.2) (free selection) when P_{CSIRS}<p.
In one example, the first subset (S1) is according to example (I.2.1.1) (window-based) when P_{CSIRS}≤p and is according to example (I.2.1.2) (free selection) when P_{CSIRS}≥p.
In one example, the first subset (S1) is according to example (I.2.1.1) (window-based) when P_{CSIRS}<p and is according to example (I.2.1.2) (free selection) when P_{CSIRS}>p.
   Here, where p is a threshold that can be fixed (e.g., p=4) or configured or reported by the UE

In one example (I.2.1.2C), the first subset (S1) is according to example (I.2.1.1) (window-based) or example (I.2.1.2) (free selection) based on a condition. The condition is according to at least one of the following examples.
In one example, the first subset (S1) is according to example (I.2.1.1) (window-based) when N₃>t or P_{CSIRS}>p, and is according to example (I.2.1.2) (free selection) otherwise (when N₃≤t and P_{CSIRS}≤P).
In one example, the first subset (S1) is according to example (I.2.1.1) (window-based) when N₃>t and P_{CSIRS}>p, and is according to example (I.2.1.2) (free selection) otherwise (when N₃≤t or P_{CSIRS}≤p).
In one example, the first subset (S1) is according to example (I.2.1.1) (window-based) when N₃≥t or P_{CSIRS}>p, and is according to example (I.2.1.2) (free selection) otherwise (when N₃<t and P_{CSIRS}≤p).
In one example, the first subset (S1) is according to example (I.2.1.1) (window-based) when N₃>t and P_{CSIRS}≥p, and is according to example (I.2.1.2) (free selection) otherwise (when N₃≤t or P_{CSIRS} <p).
In one example, the first subset (S1) is according to example (I.2.1.1) (window-based) when N₃>t or P_{CSIRS}>p, and is according to example (I.2.1.2) (free selection) otherwise (when N₃≤t and P_{CSIRS}<p).
In one example, the first subset (S1) is according to example (I.2.1.1) (window-based) when N₃>t and P_{CSIRS}≥p, and is according to example (I.2.1.2) (free selection) otherwise (when N₃≤t or P_{CSIRS}<p).
In one example, the first subset (S1) is according to example (I.2.1.1) (window-based) when N₃>t or P_{CSIRS}≥p, and is according to example (I.2.1.2) (free selection) otherwise (when N₃<t and P_{CSIRS}<p).
In one example, the first subset (S1) is according to example (I.2.1.1) (window-based) when N₃>t and P_{CSIRS}≥p, and is according to example (I.2.1.2) (free selection) otherwise (when N₃<t or P_{CSIRS}<p).
   Here, where t is a threshold that can be fixed (e.g., t=19) or configured or reported by the UE. Here, where p is a threshold that can be fixed (e.g., p=4) or configured or reported by the UE.

In one example (1.2.1.3), one of the M_{ν} FD basis vectors can be fixed, and hence M_{ν} −1 basis vectors are indicated/activated/configured/reported (either from a window-based set or freely). In one example, the fixed basis vector can be DFT vector with all ones, i.e.,

$${b}_{0} = {\frac{1}{x} [ 1 , 1 , … , 1 ]}^{T}$$

and x is a normalized factor, e.g., x=1 or \sqrt{N₃}.
In example (I.2.1.3.1), when M_{ν} =1, the first subset (S1) does not include any FD basis vector, hence need not be configured/indicated/activated.
In example (I.2.1.3.2), when M_{ν} >1, the first subset (S1) includes FD basis vectors, hence is configured/indicated/activated.
In example (I.2.1.3.3), regardless of the value of M_{ν}, the first subset (S1) is configured/indicated/activated.

In one example (I.2.1.3A), which is a variation of example (I.2.1.3), when M_{ν} =2, the FD basis vectors comprising columns of W_{f} are given by w_{f}, f=0,1, where w_{f}=[y_{0,l}^{(f)} y_{1,l}^{(f)} . . . y_{N}_{₃}_{-1,l}^{(f)}]^{T}, and

$${y}_{t , l}^{( f )} = {e}^{j \frac{ 2 π t {n}_{3 , l}^{( f )}}{{N}_{3}}} .$$

When M_{ν} =2 FD basis vectors comprising columns of W_{f} are determined from a window of size N, the index of the two basis vectors n_{3,1}=[n_{3,l}⁽⁰⁾,n_{3,l}⁽¹⁾] are determined/reported according to at the least one of the following examples.

In one example, when N=2, n_{3,l}=[n_{3,l}⁽⁰⁾,n_{3,l}⁽¹⁾]=[0,1] is fixed (hence not reported). In this case, the PMI index i_{1,6} (if layer-common) or i_{i,6,l} (if layer-specific) is fixed to 0 indicating [n_{3,l}⁽⁰⁾,n_{3,l}⁽¹⁾]=[0,1].

In one example, when N=3, n_{3,l}=[n_{3,l}⁽⁰⁾, n_{3,l}⁽¹⁾] is reported using 1 bit and the candidate values for the reporting are [0,1] and [0,2]. In this case, the PMI index i_{1,6} (if layer-common) or i_{1,6,l} (if layer-specific) is either 0 or 1 indicating [n_{3,l}⁽⁰⁾,n_{3,l}⁽¹⁾]=[0,1] or [0,2], respectively.

In one example, when N=4, n_{3,l}=[n_{3,l}⁽⁰⁾,n_{3,l}⁽¹⁾] (is reported using 2 bits and the candidate values for the reporting are [0,1], [0,2], and [0,3]. In this case, the PMI index i_{1,6} (if layer-common) or i_{1,6,l} (if layer-specific) is either 0 or 1 or 2 indicating [n_{3,l}⁽⁰⁾,n_{3,l}⁽¹⁾]=[0,1] or [0,2] or [0,3], respectively.

In one example, when N=5, n_{3,l}=[n_{3,l}⁽⁰⁾,n_{3,l}⁽¹⁾] is reported using 2 bits and the candidate values for the reporting are [0,1], [0,2], [0,3], and [0,4]. In this case, the PMI index i_{1,6} (if layer-common) or i_{1,6,l} (if layer-specific) is either 0 or 1 or 2 or 4 indicating [n_{3,l}⁽⁰⁾,n_{3,l}⁽¹⁾]=[0,1] or [0,2] or [0,3] or [0,4], respectively.

In one example, when N=3, then n_{3,l}⁽⁰⁾ is fixed to n_{3,l}⁽⁰⁾=0, and n_{3,l}⁽¹⁾ is reported using 1 bit, and the candidate values for the reporting are {1,2}. In this case, the PMI index i_{1,6} (if layer-common) or i_{1,6,l} (if layer-specific) is either 0 or 1 indicating n_{3,l}⁽¹⁾=1 or 2, respectively. Alternatively, i_{1,6} (if layer-common) or i_{1,6,l} (if layer-specific) equals n_{3,l}⁽¹⁾−1, Alternatively, n_{3,l}⁽¹⁾=i_{1,6}+1 or i_{1,6,l}+1.

In one example, when N=4, then n_{3,l}⁽⁰⁾ is fixed to n_{3,l}⁽⁰⁾=0, and n_{3,l}⁽¹⁾ is reported using 2 bits, and the candidate values for the reporting are {1,2,3}. In this case, the PMI index i_{1,6} (if layer-common) or i_{1,6,l} (if layer-specific) is either 0 or 1 or 2 indicating n_{3,l}⁽¹⁾=1 or 2 or 3, respectively. Alternatively, i_{1,6} (if layer-common) or i_{1,6,l} (if layer-specific) equals n_{3,l}⁽¹⁾−1 Alternatively, n_{3,l}⁽¹⁾=i_{1,6}+1 or i_{1,6,l}+1.

In one example, when N=5, then n_{3,l}⁽⁰⁾ is fixed to n_{3,l}⁽⁰⁾=0, and n_{3,l}⁽¹⁾ is reported using 2 bits, and the candidate values for the reporting are {1,2,3,4}. In this case, the PMI index i_{1,6} (if layer-common) or i_{1,6,l} (if layer-specific) is either 0 or 1 or 2 or 3 indicating n_{3,l}⁽¹⁾=1 or 2 or 3 or 4, respectively. Alternatively, i_{1,6} (if layer-common) or i_{1,6,l} (if layer-specific) equals n_{3,l}⁽¹⁾−1, Alternatively, n_{3,l}⁽¹⁾=i_{1,6}+1 or i_{1,6,l}+1.

In this example, when W_{f} is layer-common (i.e., one W_{f} common for all layers when ν>1), the subscript l can be dropped (omitted/removed) hence n_{3,1}[n_{3,l}⁽⁰⁾,n_{3,l}⁽¹⁾] can be replaced with n₃=[n₃⁽⁰⁾,n₃⁽¹⁾].

In one example (1.2.1.4), K of the M_{ν} FD basis vectors can be fixed, and hence M_{ν} −K basis vectors are indicated/activated/configured. In one example, one of the fixed basis vector can be DFT vector with all ones, i.e., b₀=1/x [1,1, . . . , 1]^{T}. The remaining K−1 fixed basis vectors can be within window, as described above, where the start of the window can be b₀ or b_{i mod N}_{₃}, where i is fixed to

$${N}_{3} - \frac{K}{2} or {N}_{3} - \frac{K}{2} + 1 or {N}_{3} - x where x = ⌈ \frac{K}{2} ⌉ or ⌊ \frac{K}{2} ⌋ .$$

Alternatively the remaining K−1 basis vectors can be any from the remaining N₃−1 DFT vectors. The value K can be fixed (e.g., K=1) or can be configured, e.g., via RRC and/or MACE CE and/or DCI signaling.
In example (I.2.1.4.1), when M_{ν} =1, the first subset (S1) does not include any FD basis vector, hence need not be configured/indicated/activated.
In example (I.2.1.4.2), when M_{ν} >1, the first subset (S1) includes FD basis vectors, hence is configured/indicated/activated.
In example (I.2.1.4.3), regardless of the value of M_{ν}, the first subset (S1) is configured/indicated/activated.

In one example (I.2.1.5), the M_{ν} FD basis vectors (window-based or free selection) is common for all layers, i.e., a common set of the M_{ν} FD basis vectors is configured/indicated/activated for all layers.

In one example (I.2.1.6), the M_{ν} FD basis vectors (window-based or free selection) is an intermediate set (InS) common for all layers, i.e., a common set of the M_{ν} FD basis vectors is configured/indicated/activated for all layers. And for each layer, a subset of M′_{ν} <M_{ν} FD basis vectors is determined/indicated/activated/configured independently from the InS. At least one of the examples is used/configured.
In one example (I.2.1.6.1), the InS can be configured via RRC, and per layer FD basis vectors are also configured via RRC.
In one example (I.2.1.6.2), the InS can be configured via RRC, and per layer FD basis vectors are activated via MAC CE.
In one example (I.2.1.6.3), the InS can be configured via RRC, and per layer FD basis vectors are indicated via DCI.
In one example (I.2.1.6.4), the InS can be activated via MAC CE, and per layer FD basis vectors are also activated via MAC CE.
In one example (I.2.1.6.5), the InS can be activated via MAC CE, and per layer FD basis vectors are indicated via DCI.
In one example (I.2.1.6.6), the InS can be indicated via DCI, and per layer FD basis vectors are also indicated via DCI.
In one example (I.2.1.6.7), the InS can be configured/activated/indicated (cf. example (I.2.1.6.1) through (I.2.1.6.6)), and per layer FD basis vectors are reported by the UE.

In one example (I.2.1.6A), the M_{ν} FD basis vectors (window-based or free selection) is an intermediate set (InS) common for all layers, i.e., a common set of the M_{ν} FD basis vectors is configured/indicated/activated for all layers. And a subset of M′_{ν}<M_{ν} FD basis vectors is determined/indicated/activated/configured from the InS, and this subset is layer-common (i.e., one subset) for all layers. At least one of the examples is used/configured.
In one example (I.2.1.6A.1), the InS can be configured via RRC, and the (layer-common) subset of FD basis vectors is also configured via RRC.
In one example (I.2.1.6A.2), the InS can be configured via RRC, and the (layer-common) subset of FD basis vectors is activated via MAC CE.
In one example (I.2.1.6A.3), the InS can be configured via RRC, and the (layer-common) subset of FD basis vectors is indicated via DCI.
In one example (I.2.1.6A.4), the InS can be activated via MAC CE, and the (layer-common) subset of FD basis vectors is also activated via MAC CE.
In one example (I.2.1.6A.5), the InS can be activated via MAC CE, and the (layer-common) subset of FD basis vectors is indicated via DCI.
In one example (I.2.1.6A.6), the InS can be indicated via DCI, and the (layer-common) subset of FD basis vectors is also indicated via DCI.
In one example (I.2.1.6A.7), the InS can be configured/activated/indicated (cf. example (I.2.1.6.1) through (I.2.1.6.6)), and the (layer-common) subset of FD basis vectors is reported by the UE.

In one example (I.2.1.6B), the FD basis vectors (window-based or free selection) is an intermediate set (InS) common for all layers, i.e., a common set of the M_{ν} FD basis vectors is configured/indicated/activated for all layers. And a subset of M′_{ν} <M_{ν} FD basis vectors is determined/indicated/activated/configured from the InS, and this subset is layer common (i.e., one subset) for all layers when rank=1 or 2 (ν=1 or 2), and this subset is layer specific (i.e., independent/separate subset) for each layer when rank>2 (e.g., when ν=3 or 4. In one example, the layer-common subset of FD basis vectors or the layer-specific subsets of FD basis vectors is (or are) reported by the UE as part of the CSI report (e.g., via PMI).

In one example (1.2.1.7), the component W_{f} of the codebook can be turned off by gNB. In one example, when turned off, W_{f} is a fixed, e.g., an all-one vector, b₀=1/x[1, 1, . . . , 1]^{T}.
In one example, there are two separate parameters, a first parameter for turning W_{f} ON/OFF, and a second parameter for configuring W_{f} (when turned ON). The first parameter is always provided. The second parameter may be provided only when the W_{f} is turned ON. The first parameter can be configured via RRC and/or MAC CE and/or DCI. The second parameter can be configured via RRC and/or MAC CE and/or DCI.
In another example, there is one joint parameter, which takes a value to turn W_{f} off, and at least one another value to turn the W_{f} ON and provide W_{f} jointly. The joint parameter can be configured via RRC and/or MAC CE and/or DCI.

In one example (I.2.1.8), when W_{f} is determined/configured (via RRC and/or MAC CE and/or DCI) based on a window-based set, the component W_{f} is determined/configured at least one of the following examples.
In one example, N=M_{ν} =1
   In one example, the window-based set comprises an FD index=0, which also corresponds to Mᵢₙᵢₜᵢₐₗ.
   In one example, the window-based set comprises an FD index (which also corresponds to Mᵢₙᵢₜᵢₐₗ), which is configured to the UE from n candidate values.
      When n=2, the FD index is configured from {0, y} where

$$y = \frac{{N}_{3}}{2} or \frac{{N}_{3}}{2} + 1 or \frac{{N}_{3}}{2} - 1 or ⌈ \frac{{N}_{3}}{2} ⌉ or ⌈ \frac{{N}_{3}}{2} ⌉ + 1 or ⌊ \frac{{N}_{3}}{2} ⌋ - 1 or ⌊ \frac{{N}_{3}}{2} ⌋ or ⌊ \frac{{N}_{3}}{2} ⌋ + 1 or ⌊ \frac{{N}_{3}}{2} ⌋ - 1.$$

In general, the FD index is configured from a set of values {s×y} where

$$s = 0 , 1 , … , n - 1$$

$$and$$

$$y = \frac{{N}_{3}}{n}$$

$$or$$

$$\frac{{N}_{3}}{n} + 1$$

$$or$$

$$\frac{{N}_{3}}{n} - 1$$

$$or$$

$$⌈ \frac{{N}_{3}}{n} ⌉ or ⌈ \frac{{N}_{3}}{n} ⌉ + 1$$

$$or$$

$$⌈ \frac{{N}_{3}}{n} ⌉ - 1$$

$$or$$

$$⌊ \frac{{N}_{3}}{n} ⌋ or ⌊ \frac{{N}_{3}}{n} ⌋ + 1$$

$$or$$

$$⌊ \frac{{N}_{3}}{n} ⌋ - 1.$$

In one example, N=2
   In one example, the window-based set comprises FD indices{0,1} or {N₃−1,0}.
   In one example, the window-based set comprises FD indices {0, δ−1}, {N₃, N₃+δ−2}, where δ can be fixed or configured.

In one embodiment (I.3), the first subset (S1) of components includes multiple basis sets/matrices W_{f} (window-based or free selection). One of the following examples can be fixed, or can be configured (e.g., via RRC, or MACCE or DCI based signaling).
In one example (I.3.1), the first subset (S1) of components includes one basis set/matrix W_{f} for each SD beam i∈{0,1, . . . ,2L−1} or {0,1, . . . , L−1} or {0,1, . . . , P_{CSIRS}−1}.
In one example (I.3.2), the first subset (S1) of components includes one basis set/matrix W_{f} for each layer l∈{1, . . . , ν}.
In one example (I.3.3), the first subset (S1) of components includes one basis set/matrix W_{f} for each rank ν, where ν∈Sᵣₐₙₖ, a set of allowed rank values.
In one example (I.3.4), the first subset (S1) of components includes one basis set/matrix W_{f} for each layer and rank pair (l, ν), where l∈{1, . . . , ν}.
In one example (I.3.5), the first subset (S1) of components includes one basis set/matrix W_{f} for each layer pair (l, l+1), where l∈{1, . . . , ν−1}.
In one example (I.3.6), the first subset (S1) of components includes one basis set/matrix W_{f} for each subset of layers. There could be multiple subsets of layer, which can be fixed or configured.

In one embodiment (I.4), a UE determines or is configured with the first subset (S1) of components including a set of FD basis vectors within a window on size N, as described earlier in the disclosure. At least one of the following examples is used/configured regarding the value N.

In one example (I.4.0), the value N is fixed, e.g., to 2 or 3 or 4 or N=x where x is maximum allowed rank value (e.g., via RI restriction), or N=max(2, x).

In one example (I.4.1), the value N is determined/configured from a set of values, e.g., {2,4}, or {2,3}, or {2,3,4}.
In one example, the configuration is via RRC either explicitly (based on a separate or joint parameter that provides a value of N) or implicitly (based on a RRC parameter that provides a value of a parameter which determines a value of N).
In one example, the configuration is via MAC CE either explicitly (based on a separate or joint MAC CE activation command that provides a value of N) or implicitly (based on a MAC CE command that provides a value of a parameter which determines a value of N).
In one example, the configuration is via DCI either explicitly (based on a separate or joint field whose codepoints provide a value of N) or implicitly (based on a field that provides a value of a parameter which determines a value of N).

In one example (1.4.2), the value N is determined as N=min(g, N_{c}), where g=N_{SB} or g=N₃=R×N_{SB}, N_{SB}=the number of configured SBs for CSI reporting (e.g., for CQI and/or PMI reporting) and N_{c} is a configured value, e.g., from a set of values {2,4}, or {2,3}, or {2,3,4}. The value N_{c} is configured according to at least one of the following examples.
In one example, the configuration is via RRC either explicitly (based on a separate or joint parameter that provides a value of N) or implicitly (based on a RRC parameter that provides a value of a parameter which determines a value of N).
In one example, the configuration is via MAC CE either explicitly (based on a separate or joint MAC CE activation command that provides a value of N) or implicitly (based on a MAC CE command that provides a value of a parameter which determines a value of N).
In one example, the configuration is via DCI either explicitly (based on a separate or joint field whose codepoints provide a value of N) or implicitly (based on a field that provides a value of a parameter which determines a value of N).

In one example (I.4.3), the value N is determined/configured based on the rank value.
In example (I.4.3.1), when rank=1, N is fixed (hence not configured) to N=n; and when rank>1 (e.g., 2 or 3 or 4), N≥n. In one example, n=2 is fixed or configured. When rank>1 (e.g., 2 or 3 or 4), the value of N can be fixed (e.g., N=3 or 4) or configured (e.g., from 2 or 3 or 4).
In example (I.4.3.1A), when rank=1 or 2, N is fixed to N=n; and when rank>2 (e.g., 3 or 4), N≥n. In one example, n=2 is fixed or configured. When rank>2 (e.g., 3 or 4), the value of N can be fixed (e.g., N=3 or 4) or configured (e.g., from 2 or 3 or 4).
In example (I.4.3.2), the higher layer rank restriction parameter (e.g., RI-restriction-r17) configures a set of allowed rank values S to the UE. When S={1}, i.e., only rank 1 is allowed, then N=n is fixed (hence not configured); otherwise (when S includes a rank value greater than 1), i.e., allowed rank value(s) include at least one value>1, then N>n. In one example, n=2 is fixed or configured. When rank>1, the value of N can be fixed (e.g., N=3 or 4) or configured (e.g., from {3,4}).
In example (I.4.3.3), the higher layer rank restriction parameter (e.g., RI-restriction-r17) configures a set of allowed rank values S to the UE. When S={1}, i.e., only rank 1 is allowed, then N=n is fixed (hence not configured); otherwise (when S includes a rank value greater than 1), i.e., allowed rank value(s) include at least one rank>1, then N≥n. In one example, n=2 is fixed or configured. When rank>1, the value of N can be fixed (e.g., N=2 or 3 or 4) or configured (e.g., from {2,3} or {3,4} or {2,3,4}).
In example (1.4.3.4), the higher layer rank restriction parameter (e.g., RI-restriction-r17) configures a set of allowed rank values S to the UE. When S={1,2}, i.e., only rank 1-2 is allowed, then N=n is fixed (hence not configured); otherwise (when S includes a rank value greater than 2), i.e., allowed rank value(s) include at least one value>2, then N>n. In one example, n=2 is fixed or configured. When rank>2, the value of N can be fixed (e.g., N=3 or 4) or configured (e.g., from {3,4}).
In example (1.4.3.5), the higher layer rank restriction parameter (e.g., RI-restriction-r17) configures a set of allowed rank values S to the UE. When S={1,2}, i.e., only rank 1-2 is allowed, then N=n is fixed (hence not configured); otherwise (when S includes a rank value greater than 2), i.e., allowed rank value(s) include at least one rank>2, then N≥n. In one example, n=2 is fixed or configured. When rank>2, the value of N can be fixed (e.g., N=2 or 3 or 4) or configured (e.g., from {2,3} or {3,4} or {2,3,4}).

In the above examples, the value of n (when configured) and/or the value of N (when configured) are configured according to at least one of the following examples.
In one example, the configuration is via RRC either explicitly (based on a separate or joint parameter that provides a value of N) or implicitly (based on a RRC parameter that provides a value of a parameter which determines a value of N).
In one example, the configuration is via MAC CE either explicitly (based on a separate or joint MAC CE activation command that provides a value of N) or implicitly (based on a MAC CE command that provides a value of a parameter which determines a value of N).
In one example, the configuration is via DCI either explicitly (based on a separate or joint field whose codepoints provide a value of N) or implicitly (based on a field that provides a value of a parameter which determines a value of N).

In one example, the reports a preferred value of n and/or N in its capability reporting, and the configuration of n and/or N is subject to the UE capability reporting.

In one example, the above examples (I.4.0 through (I.4.3) apply only when the configuration is such that the number of columns in the W_{f} matrix is M_{ν} >1, where M_{ν} >1 can correspond to a single (fixed) value M_{ν} =2 or a configured value, e.g., from {2,3} or {2,4}. In this case, when M_{ν} =1 is configured, then the above examples (I.4.0) through (I.4.3) do not apply, hence, the window-based set of FD basis vectors is not needed/configured.

In one example, the above examples (I.4.0) through (I.4.3) apply regardless of the value of M_{ν} (fixed or configured), e.g., regardless of whether M_{ν} =1 or M_{ν} >1 (e.g., M_{ν}). In particular, when M_{ν} =1 is configured, the value of N is fixed, e.g., N=1.

In one embodiment (I1.1), when a UE is configured with a CSI reporting based on a subset of PMI components (S1) being configured (or activated/indicated) and a subset of PMI components (S2) being reported, as described in this disclosure, the UE is configured to or expected to calculate/report the CSI parameters according to at least one of the following examples.

In one example (II.1.1), when both layer indicator (LI) indicating a layer from a plurality of layers (e.g., when rank>1) and CRI indicating a CSI-RS resource index can be reported, e.g., when the higher layer parameter reportQuantity is set to ‘cri-RI-LI-PMI-CQI’, the UE shall calculate CSI parameters (if reported) assuming the following dependencies between CSI parameters (if reported)
LI shall be calculated conditioned on the reported CQI, PMI components (S2), RI and CRI, and the configured (or activated/indicated) PMI components (S1)
CQI shall be calculated conditioned on the reported PMI components (S2), RI and CRI, and the configured (or activated/indicated) PMI components (S1)
the reported PMI components (S2) shall be calculated conditioned on the configured (or activated/indicated) PMI components (S1), and the reported RI and CRI
RI shall be calculated conditioned on the reported CRI.

In one example (II.1.2), when CRI is not reported but LI can be reported, e.g., when the higher layer parameter reportQuantity is set to ‘RI-LI-PMI-CQI’, the UE shall calculate CSI parameters (if reported) assuming the following dependencies between CSI parameters (if reported)
LI shall be calculated conditioned on the reported CQI, PMI components (S2) and RI, and the configured (or activated/indicated) PMI components (S1)
CQI shall be calculated conditioned on the reported PMI components (S2) and RI, and the configured (or activated/indicated) PMI components (S1)
the reported PMI components (S2) shall be calculated conditioned on the configured (or activated/indicated) PMI components (S1), and the reported RI.

In one example (II.1.3), when LI is not reported but CRI can be reported, e.g., when the higher layer parameter reportQuantity is set to ‘cri-RI-PMI-CQI’, the UE shall calculate CSI parameters (if reported) assuming the following dependencies between CSI parameters (if reported)
CQI shall be calculated conditioned on the reported PMI components (S2), RI and CRI, and the configured (or activated/indicated) PMI components (S1)
the reported PMI components (S2) shall be calculated conditioned on the configured (or activated/indicated) PMI components (S1), and the reported RI and CRI
RI shall be calculated conditioned on the reported CRI.

In one example (II.1.4), when LI and CRI are not reported, e.g., when the higher layer parameter reportQuantity is set to ‘RI-PMI-CQI’, the UE shall calculate CSI parameters (if reported) assuming the following dependencies between CSI parameters (if reported)
CQI shall be calculated conditioned on the reported PMI components (S2) and RI, and the configured (or activated/indicated) PMI components (S1)
the reported PMI components (S2) shall be calculated conditioned on the configured (or activated/indicated) PMI components (S1), and the reported RI.

In one embodiment (III), a UE is configured with higher layer parameter codebookType set to ‘typeII-PortSelection-r17’ for CSI reporting based on a new (Rel. 17) Type II port selection codebook which has a component W_{f} for FD basis selection (as described in embodiment A.1 and A.2). When the UE is allowed to report rank (number of layers) ν≥1 (e.g., via higher layer parameter rank restriction), then the details about the component W_{f} is according to at least one of the following embodiments.

In one embodiment (III.1), the FD basis vectors comprising columns of the W_{f} matrix are limited/restricted/determined within a single window with size N, which is configured to the UE, where the FD bases or basis vectors in the window must be consecutive from an orthogonal DFT matrix. In particular, for rank ν, the M_{ν} FD basis vectors comprise columns of the basis matrix W_{f} (cf. equation 5) and are selected/determined from the configured window/set of orthogonal DFT vectors. In one example, the orthogonal DFT vectors are included in the full set of DFT vectors {b_{f}: f=0,1, . . . , N₃−1} where

$${b}_{f} = {\frac{1}{x} [ {e}^{f \frac{j 2π0}{{N}_{3}}} , {e}^{f \frac{j 2π1}{{N}_{3}}} , … , {e}^{f \frac{j 2π ( {N}_{3} - 1 )}{{N}_{3}}} ]}^{T}$$

and x is a normalized factor, e.g., x=1 or \sqrt{N₃}.

In one example, the window can be parametrized as a window. For example, the indices of the FD basis vectors in the set are given by mod(Mᵢₙᵢₜᵢₐₗ+n, N₃), n=0,1, . . . , N−1, which correspond to a window-based basis set comprising N adjacent FD indices with modulo-shift by N₃, where Mᵢₙᵢₜᵢₐₗ is the starting index of the basis set. An example is shown in FIG. 15. Note that the window-based basis set is completely parameterized by Mᵢₙᵢₜᵢₐₗ and N. At least one of the following examples can be used/configured to determine W_{f}.
Both Mᵢₙᵢₜᵢₐₗ and N are fixed.
Both Mᵢₙᵢₜᵢₐₗ and N are configured to the UE (via RRC and/or MAC CE and/or DCI).
Both Mᵢₙᵢₜᵢₐₗ and N are reported by the UE.
Mᵢₙᵢₜᵢₐₗ is fixed and N is configured to the UE (via RRC and/or MAC CE and/or DCI).
Mᵢₙᵢₜᵢₐₗ is fixed and N is reported by the UE.
Mᵢₙᵢₜᵢₐₗ is configured to the UE (via RRC and/or MAC CE and/or DCI) and N is fixed.
Mᵢₙᵢₜᵢₐₗ is configured to the UE (via RRC and/or MAC CE and/or DCI) and N is reported by the UE.
Mᵢₙᵢₜᵢₐₗ is reported by the UE and N is fixed.
Mᵢₙᵢₜᵢₐₗ is reported by the UE and N is configured to the UE (via RRC and/or MAC CE and/or DCI).

In one example, when Mᵢₙᵢₜᵢₐₗ is fixed, it can be fixed, for example, to Mᵢₙᵢₜᵢₐₗ=0 or Mᵢₙᵢₜᵢₐₗ=N₃−x where

$$x = \frac{N}{2}$$

$$or$$

$$⌈ \frac{N}{2} ⌉ or ⌊ \frac{N}{2} ⌋ .$$

Here, the notation ┌z┐ and └z┘ denote the ceiling and the flooring functions, respectively. In one example, when Mᵢₙᵢₜᵢₐₗ is reported or configured, it is reported or indicated via an indicator iᵢₙᵢₜᵢₐₗ, which is given by

$${i}_{initial} = \{ \begin{matrix}{M}_{initial} & {M}_{initial} = 0 \\ {M}_{initial} + N & {M}_{initial} < 0\end{matrix}$$

In one example, N=M_{ν}. In one example, N=aM_{ν} where a is fixed, e.g., a=2. In one example, N is configured.

The window size N is such that N≥M_{ν}. When N=M_{ν}, the UE uses the configured window/set to obtain/construct W_{f} component of the codebook, and there is no need for any reporting from the UE about W_{f}. When N>M_{ν}, then the UE selects M_{ν} basis vectors from the configured window/set to obtain/construct W_{f} component of the codebook, and in this case, the UE reports this selection as part of the CSI reporting (e.g., via a PMI component i_{1,6} when this reporting is layer-common or i_{1,6,l} when this reporting is layer-specific).

Note that when N=N₃, the window includes all N₃ orthogonal DFT vectors, hence the M_{ν} FD basis vectors can be any of the N₃ DFT basis vectors.

In one embodiment (III.2), when the UE is allowed to report a rank (or number of layers) value ν>1 (e.g., when the higher layer parameter rank-restriction allows rank>1 CSI reporting), the component W_{f} M_{ν} FD basis vectors is determined/reported according to at least one of the following examples. When multiple of the following examples is supported, then one of the support examples can be configured to the UE (e.g., via RRC and/or MAC CE and/or DCI). This configuration can be subject to the UE capability reporting about rank>1 CSI reporting.
In one example (III.2.1), the M_{ν} FD basis vectors are common (the same) for all layers l∈{1, . . . , ν}, i.e., only one set of M_{ν} FD basis vectors are determined/reported by the UE regardless of the rank ν value.
In one example (III.2.2), the M_{ν} FD basis vectors are common (the same) for a layer pair (l, l+1) where l∈{1,3, . . . , ν−1}, i.e., one set of M_{ν} FD basis vectors are determined/reported by the UE for each layer pair (1,2), (3,4) etc.
   When ν=2, one set of M_{ν} FD basis vectors are determined/reported by the UE.
   When ν=3, one set of M_{ν} FD basis vectors are determined/reported by the UE for layer pair (1,2), and another set of M_{ν} FD basis vectors are determined/reported by the UE for layer 3.
   When ν=4, one set of M_{ν} FD basis vectors are determined/reported by the UE for layer pair (1,2), and another set of M_{ν} FD basis vectors are determined/reported by the UE for layer pair (3,4).
In one example (III.2.3), the M_{ν} FD basis vectors are common (the same) for each subset of layers. There could be multiple subsets of layer, which can be fixed or configured.
In one example (III.2.4), the M_{ν} FD basis vectors are independent (separate) for all layers, i.e., one set of M_{ν} FD basis vectors are determined/reported by the UE for each layer l=1, . . . , ν.
In one example (III.2.5), the M_{ν} FD basis vectors are according to example III.2.1 or example III.2.4 (or example III.2.2) depending on a configuration (e.g., RRC and/or MAC CE and/or DCI).
In one example (III.2.6), the M_{ν} FD basis vectors are according to example III.2.1 or example III.2.4 (or example III.2.2) depending on a condition. At least one of the following examples is used for the condition.
   In one example, the condition is based on number of ports P_{CSIRS}, for example, example III.2.1 is used when P_{CSIRS}>t, and example III.2.4 is used when P_{CSIRS}≤t, where t can be fixed (e.g., to 4 or 8) or configured.
   In one example, the condition is based on M_{ν}, for example, example III.2.1 is used when M_{ν}>t, and example III.2.4 is used when M_{ν} ≤t, where t can be fixed (e.g., to 2) or configured.
   In one example, the condition is based on max rank value, for example, example III.2.1 is used when max rank>t, and example III.2.4 is used when max rank t, where t can be fixed (e.g., to 2) or configured.
   In one example, the condition is based on rank value, for example, example III.2.1 is used when rank>t, and example III.2.4 is used when rank≤t, where t can be fixed (e.g., to 2) or configured.

In one embodiment (III.3), at least one of the following examples is used/configured regarding the M_{ν} value.
In one example (III.3.1), the M_{ν} value can be the same for all rank values and all layers l=1, . . . , ν, i.e., M_{ν} =M for all values of ν and l.
In one example (III.3.2), the M_{ν} value can be the same for rank ν=1,2 and all layers l=1, . . . , ν, i.e., M_{ν} =M¹ for ν=1,2 and all 1, and the M_{ν} value be the same for rank ν=3,4 and all layers l=1, . . . , ν, i.e., M_{ν} =M² for ν=3,4 and all l; however, M¹≠M². In one example, M¹≥M².
In one example (III.3.3), the M_{ν} value can be different for different rank values but are common (the same) for all layers of a given rank ν.
In one example (III.3.4), the M_{ν} value can be the same for layer l=1,2 and all rank ν≥2, i.e., M_{ν} =M¹ for l=1,2 and all ν>2, and the M_{ν} value be the same for layer ν=3,4 and all rank ν≥2, i.e., M_{ν} =M² for l=3,4 and all rank ν≥2; however, M¹≠M². In one example, M¹≥M².

In one embodiment (III.4), one of the M_{ν} FD basis vectors can be fixed, and hence M_{ν} −1 basis vectors are indicated/activated/configured/reported (either from a window-based set or freely). In one example, the fixed basis vector can be DFT vector with all ones, i.e., DFT basis vector

$${b}_{0} = {\frac{1}{x} [ 1 , 1 , … , 1 ]}^{T}$$

indicated by index n₃=0 or n₃⁽⁰⁾=0 and f=0, and x is a normalized factor, e.g., x=1 or \sqrt{N₃}.
In one example (III.4.1), when M_{ν} =1, there is no need for any configuration/indication/activation and/or reporting from the UE.
In one example (III.4.2), when M_{ν} >1, there is a need for configuration/indication/activation (window for W_{f}) and/or reporting (of M_{ν} −1 basis vectors) from the UE (when N>M_{ν}).
In one example (III.4.3), regardless of the value of M_{ν}, there is a configuration/indication/activation (window for Wf) and/or reporting from the UE.

In one embodiment (III.5), which is a variation of embodiment III.4, when M_{ν} =2, the FD basis vectors comprising columns of W_{f} are given by w_{f}, f=0,1, where w_{f}=[y_{0,l}^{(f)} y_{1,l}^{(f)} . . . y_{N}_{₃}_{-1,l}^{(f)}]^{T}, and

$${y}_{t , l}^{( f )} = {e}^{j \frac{2 {π tn}_{3 , l}^{( f )}}{{N}_{3}}} .$$

When M_{ν} =2 FD basis vectors comprising columns of W_{f} are determined from a window of size N, the index of the two basis vectors n_{3,l}=[n_{3,l}⁽⁰⁾,n_{3,l}⁽¹⁾] are determined/reported according to at the least one of the following examples.

In one example, when N=2, n_{3,l}=[n_{3,l}⁽⁰⁾,n_{3,l}⁽¹⁾]=[0,1] is fixed (hence not reported). In this case, the PMI index i_{1,6} (if layer-common) or i_{1,6,l} (if layer-specific) is fixed to 0 indicating [n_{3,l}⁽⁰⁾,n_{3,l}⁽¹⁾]=[0,1], and is not reported.

In one example, when N=3, n₃, [n_{3,l}⁽⁰⁾,n_{3,l}⁽¹⁾] is reported using 1 bit and the candidate values for the reporting are [0,1] and [0,2]. In this case, the PMI index i_{1,6} (if layer-common) or i_{1,6,l} (if layer-specific) is either 0 or 1 indicating [n_{3,l}⁽⁰⁾,n_{3,l}⁽¹⁾]=[0,1] or [0,2], respectively.

In one example, when N=4, n_{3,l}=[n_{3,l}⁽⁰⁾,n_{3,l}⁽¹⁾] is reported using 2 bits and the candidate values for the reporting are [0,1], [0,2], and [0,3]. In this case, the PMI index i_{1,6} (if layer-common) or i_{1,6,l} (if layer-specific) is either 0 or 1 or 2 indicating [n_{3,l}⁽⁰⁾,n_{3,l}⁽¹⁾]=[0,1] or [0,2] or [0,3], respectively.

In one example, when N=5, n_{3,l}=[n_{3,l}⁽⁰⁾,n_{3,l}⁽¹⁾] is reported using 2 bits and the candidate values for the reporting are [0,1], [0,2], [0,3], and [0,4]. In this case, the PMI index i_{1,6} (if layer-common) or i_{1,6}, (if layer-specific) is either 0 or 1 or 2 or 4 indicating [n_{3,l}⁽⁰⁾,n_{3,l}⁽¹⁾]=[0,1] or [0,2] or [0,3] or [0,4], respectively.

In one example, when N=3, then n_{3,l}⁽⁰⁾ is fixed to n_{3,l}⁽⁰⁾=0, and n_{3,l}⁽¹⁾ is reported using 1 bit, and the candidate values for the reporting are {1,2}. In this case, the PMI index i_{1,6} (if layer-common) or i_{1,6,l} (if layer-specific) is either 0 or 1 indicating n_{3,l}⁽¹⁾=1 or 2, respectively. Alternatively, i_{1,6} (if layer-common) or i_{1,6,l} (if layer-specific) equals n_{3,l}⁽¹⁾−1, Alternatively, n_{3,l}⁽¹⁾=i_{1,6}+1 or i_{1,6,l}+1.

In one example, when N=4, then n_{3,l}⁽⁰⁾ is fixed to n_{3,l}⁽⁰⁾=0, and n_{3,l}⁽¹⁾ is reported using 2 bits, and the candidate values for the reporting are {1,2,3}. In this case, the PMI index i_{1,6} (if layer-common) or i_{1,6,l} (if layer-specific) is either 0 or 1 or 2 indicating n_{3,l}⁽¹⁾=1 or 2 or 3, respectively. Alternatively, i_{1,6} (if layer-common) or i_{1,6,l} (if layer-specific) equals n_{3,l}⁽¹⁾−1, Alternatively, n_{3,l}⁽¹⁾=i_{1,6}+1 or i_{1,6,l}+1.

In one example, when N=5, then n_{3,l}⁽⁰⁾ is fixed to n_{3,l}⁽⁰⁾=0, and n_{3,l}⁽¹⁾ is reported using 2 bits, and the candidate values for the reporting are {1,2,3,4}. In this case, the PMI index i_{1,6} (if layer-common) or i_{1,6,l} (if layer-specific) is either 0 or 1 or 2 or 3 indicating n_{3,l}⁽¹⁾=1 or 2 or 3 or 4, respectively. Alternatively, i_{1,6} (if layer-common) or i_{1,6,l} (if layer-specific) equals n_{3,l}⁽¹⁾−1, Alternatively, n_{3,l}⁽¹⁾=i_{1,6}+1 or i_{1,6,l}+1.

In this example, when W_{f} is layer-common (i.e., one W_{f} common for all layers when ν>1), the subscript l can be dropped (omitted/removed) hence n_{3,1}=[n_{3,l}⁽⁰⁾,n_{3,l}⁽¹⁾] can be replaced with n₃=[n₃⁽⁰⁾,n₃⁽¹⁾].

In one example (III.5.0), when M_{ν} =2, the UE can be configured with a window of size N, where N is fixed, e.g., to 2 or 3 or 4 or 5. If Mᵢₙᵢₜ is also fixed (e.g., to 0), then the configuration of the window can be implicit based on the configuration of the value M_{ν} =2, or explicit via a higher layer parameter.

In one example (III.5.1), when M_{ν} =2, the UE can be configured with a window of size N, where a single N value is configured (common) for all rank values, and N takes a value from {2, x}.
In one example, the value x is fixed to 3.
In one example, the value x is fixed to 4.
In one example, the value x is fixed to 5.
In one example, the value x is {3,4}.
In one example, the value x is {3,5}.
In one example, the value x is {4,5}.
In one example, the value x is {3,4,5}.

In one example (III.5.2), when M_{ν} =2, the UE can be configured with a window of size N, where two N values (a, b) are configured, and a and b take a value from {2, x} and can be the same or different.
In one example, the value x is fixed to 3.
In one example, the value x is fixed to 4.
In one example, the value x is fixed to 5.
In one example, the value x is {3,4}.
In one example, the value x is {3,5}.
In one example, the value x is {4,5}.
In one example, the value x is {3,4,5}.

In one example (III.5.3), when M_{ν} =2, the UE can be configured with a window of size N, where two N values (a, b) are configured, a takes a value from {2, x} and b takes a value from {2, y}, and the values x and y are different.
In one example, x=3 and y=4.
In one example, x=3 and y=5.
In one example, x=4 and y=5.
In one example, x=4 and y=3.
In one example, x=5 and y=3.
In one example, x=5 and y=4.
In one example, x={3,4} and y=5.
In one example, x={4,5} and y=3.
In one example, x={3,5} and y=4.
In one example, y={3,4} and x=5.
In one example, y={4,5} and x=3.
In one example, y={3,5} and x=4.

In one example (III.5.4), when M_{ν} =2, the UE can be configured with a window of size N, where there are two N values (a, b), a being configured and b being determined based on the configured value a, a takes a value from {2, x}, and the values x and y can be the same or different. In one example, b=a+1. In one example, b=min (a+1, k) where k can be fixed, e.g., k=5. In one example, b=a−1. In one example, b=max (a−1, k) where k can be fixed, e.g., k=3.
In one example, the value x is fixed to 3.
In one example, the value x is fixed to 4.
In one example, the value x is fixed to 5.
In one example, the value x is {3,4}.
In one example, the value x is {3,5}.
In one example, the value x is {4,5}.
In one example, the value x is {3,4,5}.

In one example (III.5.5), the details about (a, b), as described on example III.5.2 and III.5.3, are according to at least one of the following examples.
In one example, a is for rank 1 and b is for rank 2-4.
In one example, a is for rank 1-2 and b is for rank 3-4.
In one example, a is for rank 1-3 and b is for rank 4.
In one example, a is for layer 1 and b is for layer 2-4.
In one example, a is for layer 1-2 and b is for layer 3-4.
In one example, a is for layer 1-3 and b is for layer 4.

In one example, a single N value (cf. example III.5.1) is configured when the maximum allowed rank (e.g., via higher layer rank restriction) is 1 or 1-2 or ν≤t where t is fixed/configured threshold; and two N values (cf. example III.5.2 through III.5.4) are configured otherwise.

In one embodiment (III.6), the UE reports a UE capability information including an information about the value(s) of N that the UE supports. The configuration about N is subject to the UE capability reporting.

In one example, the support for N=2 is mandatory for a UE supporting M_{ν} =2, and the support for any N>2 is optional, hence require additional capability signaling from the UE, which could be a separate capability or a part of another capability signaling (e.g., the capability signaling for the support of M_{ν} =2 or M_{ν} >1 or the capability signaling for the support of rank 3-4). When the UE reports the support for any N>2, the UE can be configured with a value of N (window size) that can be 2 or a value>2 that is supported by the UE. When the UE does not report anything about the support for any N>2 or reports the support for N=2 only, the UE can be only be configured with a value of N (window size) equal to 2.

Any of the above embodiments can be utilized independently or in combination with at least one other embodiment.

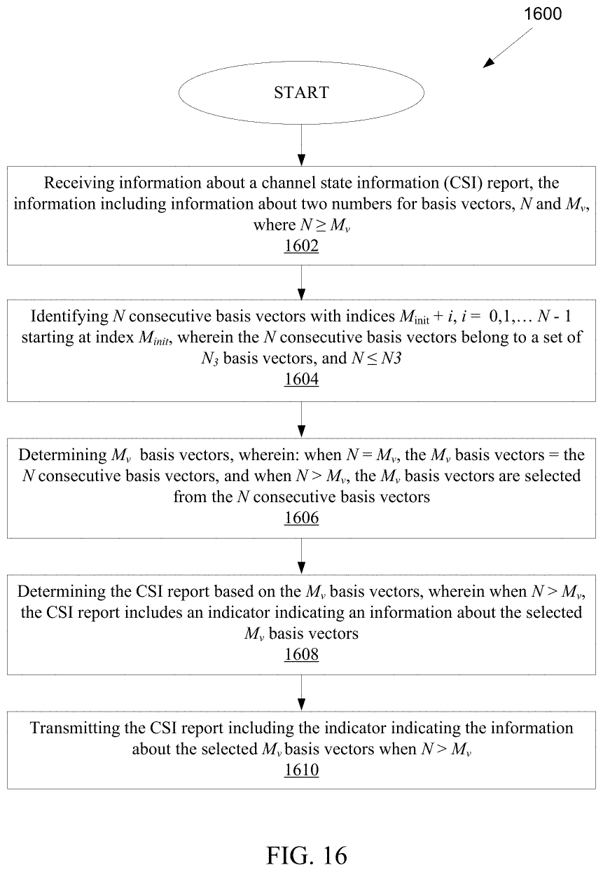

FIG. 16 illustrates a flow chart of a method 1600 for operating a user equipment (UE), as may be performed by a UE such as UE 116, according to embodiments of the present disclosure. The embodiment of the method 1600 illustrated in FIG. 16 is for illustration only. FIG. 18 does not limit the scope of this disclosure to any particular implementation.

As illustrated in FIG. 16, the method 1600 begins at step 1602. In step 1602, the UE (e.g., 111-116 as illustrated in FIG. 1) receives information about a channel state information (CSI) report, the information including information about two numbers for basis vectors, N and M_{ν}, where N≥M_{ν}; identifying N consecutive basis vectors with indices Mᵢₙᵢₜ+i, i=0,1, . . . , N−1 starting at index Mᵢₙᵢₜ, wherein the N consecutive basis vectors belong to a set of N₃ basis vectors, and N≤N₃.

In step 1604, the UE determines M_{ν} basis vectors, wherein: when N=M_{ν}, the M_{ν} basis vectors=the N consecutive basis vectors, and when N>M_{ν}, the M_{ν} basis vectors are selected from the N consecutive basis vectors.

In step 1606, the UE determines the CSI report based on the M_{ν} basis vectors, wherein when N>M_{ν}, the CSI report includes an indicator indicating an information about the selected M_{ν} basis vectors.

In step 1608, the UE transmits the CSI report including the indicator indicating the information about the selected M_{ν} basis vectors when N>M_{ν}.

In one embodiment, Mᵢₙᵢₜ=0.

In one embodiment, when N>M_{ν}, one of the M_{ν} basis vectors is fixed and corresponds to index i=0, the information about the selected M_{ν} basis vectors corresponds to the remaining M_{ν} −1 basis vectors, and the indicator indicates M_{ν} −1 out of remaining N−1 basis vectors with indices i=1, . . . , N−1, and includes

$$⌈ {log}_{2} ( \begin{matrix}N - 1 \\ {M}_{v} - 1\end{matrix} ) ⌉$$

bits for reporting, where ┌ ┐ is a ceiling function.

In one embodiment, when M_{ν} =2, N is configured via a higher layer signaling from {2, x}, where x is a value larger than 2, and when N=x, the indicator indicates a second basis vector out of remaining N−1 basis vectors, and includes [log₂(N−1)] bits for reporting, where ┌ ┐ is a ceiling function.

In one embodiment, x=4, and when N=x, the indicator indicates a second basis vector out of remaining 3 basis vectors with indices i=1,2,3, and includes 2 bits for reporting.

In one embodiment, when N>M_{ν} and the CSI report corresponds to multiple layers, the selected M_{ν} basis vectors are common for all layers.

In one embodiment, the set of N₃ basis vectors comprises orthogonal DFT vectors

$${b}_{f} = {\frac{1}{x} [ {e}^{f \frac{j 2π0}{{N}_{3}}} , {e}^{f \frac{j 2π1}{{N}_{3}}} , … , {e}^{f \frac{j 2π ( {N}_{3} - 1 )}{{N}_{3}}} ]}^{T} ,$$

wherein f=0,1, . . . , N₃−1.

In one embodiment, N=min(N₃, K), where K is configured via the information.

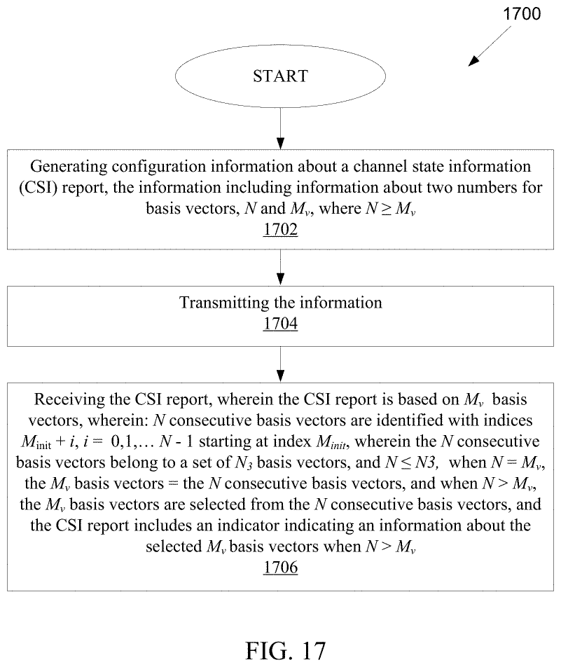

FIG. 17 illustrates a flow chart of another method 1700, as may be performed by a base station (BS) such as BS 102, according to embodiments of the present disclosure. The embodiment of the method 1700 illustrated in FIG. 17 is for illustration only. FIG. 17 does not limit the scope of this disclosure to any particular implementation.

As illustrated in FIG. 17, the method 1700 begins at step 1702. In step 1702, the BS (e.g., 101-103 as illustrated in FIG. 1), generates information about a channel state information (CSI) report, the information including information about two numbers for basis vectors, N and M_{ν}, where N≥M_{ν}.

In step 1704, the BS transmits the information.

In step 1706, the BS receives the CSI report, wherein: the CSI report is based on M_{ν} basis vectors, wherein: N consecutive basis vectors are identified with indices Mᵢₙᵢₜ+i, i=0,1, . . . , N−1 starting at index Mᵢₙᵢₜ, wherein the N consecutive basis vectors belong to a set of N₃ basis vectors, and N≤N₃, when N=M_{ν}, the M_{ν} basis vectors=N consecutive basis vectors, when N>M_{ν}, the M_{ν} basis vectors are selected from the N consecutive basis vectors, and the CSI report includes an indicator indicating an information about the selected M_{ν} basis vectors when N>M_{ν}.

In one embodiment, Mᵢₙᵢₜ=0.

In one embodiment, when N>M_{ν}, one of the M_{ν} basis vectors is fixed and corresponds to index i=0, the information about the selected M_{ν} basis vectors corresponds to the remaining M_{ν} −1 basis vectors, and the indicator indicates M_{ν} −1 out of remaining N−1 basis vectors with indices i=1, . . . , N−1, and includes

$$⌈ {log}_{2} ( \begin{matrix}N - 1 \\ {M}_{v} - 1\end{matrix} ) ⌉$$

bits for reporting, where ┌ ┐ is a ceiling function.

In one embodiment, when M_{ν} =2, N is configured via a higher layer signaling from {2, x}, where x is a value larger than 2, and when N=x, the indicator indicates a second basis vector out of remaining N−1 basis vectors, and includes ┌log₂(N−1)┐ bits for reporting, where ┌ ┐ is a ceiling function.

In one embodiment, x=4, and when N=x, the indicator indicates a second basis vector out of remaining 3 basis vectors with indices i=1,2,3, and includes 2 bits for reporting.

In one embodiment, when N>M_{ν} and the CSI report corresponds to multiple layers, the selected M_{ν} basis vectors are common for all layers.

In one embodiment, the set of N₃ basis vectors comprises orthogonal DFT vectors

$${b}_{f} = {\frac{1}{x} [ {e}^{f \frac{j 2π0}{{N}_{3}}} , {e}^{f \frac{j 2π1}{{N}_{3}}} , … , {e}^{f \frac{j 2π ( {N}_{3} - 1 )}{{N}_{3}}} ]}^{T} ,$$

wherein f=0,1, . . . , N₃−1.

In one embodiment, N=min(N₃, K), where K is configured via the information.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a channel state information (CSI) report, the information including information about two numbers for basis vectors, N and M_{ν}, where N≥M_{ν}; and
a processor operably coupled to the transceiver, the processor, based on the information, configured to:
identify N consecutive basis vectors with indices Mᵢₙᵢₜ+i, i=0,1, . . . , N−1 starting at index Mᵢₙᵢₜ, wherein the N consecutive basis vectors belong to a set of N₃ basis vectors, and N≤N₃;
determine M_{ν} basis vectors, wherein:
when N=M_{ν}, the M_{ν} basis vectors=the N consecutive basis vectors, and
when N>M_{ν}, the M_{ν} basis vectors are selected from the N consecutive basis vectors; and
determine the CSI report based on the M_{ν} basis vectors, wherein when N>M_{ν}, the CSI report includes an indicator indicating an information about the selected M_{ν} basis vectors;
wherein the transceiver is configured to transmit the CSI report including the indicator indicating the information about the selected M_{ν} basis vectors when N>M_{ν}.

2. The UE of claim 1, wherein Mᵢₙᵢₜ=0.

3. The UE of claim 2, wherein when N>M_{ν},
one of the M_{ν} basis vectors is fixed and corresponds to index i=0,
the information about the selected M_{ν} basis vectors corresponds to the remaining M_{ν} −1 basis vectors, and
the indicator indicates M_{ν} −1 out of remaining N−1 basis vectors with indices i=1, . . . , N−1, and includes
$$⌈ {log}_{2} ( \begin{matrix}N - 1 \\ {M}_{v} - 1\end{matrix} ) ⌉$$
bits for reporting, where ┌ ┐ is a ceiling function.

4. The UE of claim 3, wherein:
when M_{ν} =2, N is configured via a higher layer signaling from {2, x}, where x is a value larger than 2, and
when N=x, the indicator indicates a second basis vector out of remaining N−1 basis vectors, and includes ┌log₂(N−1)┐ bits for reporting, where ┌ ┐ is a ceiling function.

5. The UE of claim 4, wherein x=4, and when N=x, the indicator indicates a second basis vector out of remaining 3 basis vectors with indices i=1,2,3, and includes 2 bits for reporting.

6. The UE of claim 1, wherein when N>M_{ν} and the CSI report corresponds to multiple layers, the selected M_{ν} basis vectors are common for all layers.

7. The UE of claim 1, wherein the set of N₃ basis vectors comprises orthogonal DFT vectors
$${b}_{f} = {\frac{1}{x} [ {e}^{f \frac{j 2π0}{{N}_{3}}} , {e}^{f \frac{j 2π1}{{N}_{3}}} , … , {e}^{f \frac{j 2π ( {N}_{3} - 1 )}{{N}_{3}}} ]}^{T} ,$$
wherein f=0,1, . . . ,N₃−1.

8. The UE of claim 1, wherein N=min(N₃, K), where K is configured via the information.

9. A base station (BS) comprising:
a processor configured to generate information about a channel state information (CSI) report, the information including information about two numbers for basis vectors, N and M_{ν}, where N≥M_{ν}; and
a transceiver operably coupled to the processor, the transceiver configured to:
transmit the information; and
receive the CSI report,
wherein:
the CSI report is based on M_{ν} basis vectors, wherein:
N consecutive basis vectors are identified with indices Mᵢₙᵢₜ+i, i=0,1, . . . , N−1 starting at index Mᵢₙᵢₜ, wherein the N consecutive basis vectors belong to a set of N₃ basis vectors, and N≤N₃,
when N=M_{ν}, the M_{ν} basis vectors=N consecutive basis vectors,
when N>M_{ν}, the M_{ν} basis vectors are selected from the N consecutive basis vectors, and
the CSI report includes an indicator indicating an information about the selected M_{ν} basis vectors when N>M_{ν}.

10. The BS of claim 9, wherein Mᵢₙᵢₜ=0.

11. The BS of claim 10, wherein when N>M_{ν},
one of the M_{ν} basis vectors is fixed and corresponds to index i=0,
the information about the selected M_{ν} basis vectors corresponds to the remaining M_{ν} −1 basis vectors, and
the indicator indicates M_{ν} −1 out of remaining N−1 basis vectors with indices i=1, . . . , N−1, and includes
$$⌈ {log}_{2} ( \begin{matrix}N - 1 \\ {M}_{v} - 1\end{matrix} ) ⌉$$
bits for reporting, where ┌ ┐ is a ceiling function.

12. The BS of claim 11, wherein:
when M_{ν} =2, N is configured via a higher layer signaling from {2, x}, where x is a value larger than 2, and
when N=x, the indicator indicates a second basis vector out of remaining N−1 basis vectors, and includes ┌log₂(N−1)┐ bits for reporting, where ┌ ┐ is a ceiling function.

13. The BS of claim 12, wherein x=4, and when N=x, the indicator indicates a second basis vector out of remaining 3 basis vectors with indices i=1,2,3, and includes 2 bits for reporting.

14. The BS of claim 9, wherein when N>M_{ν} and the CSI report corresponds to multiple layers, the selected M_{ν} basis vectors are common for all layers.

15. The BS of claim 9, wherein the set of N₃ basis vectors comprises orthogonal DFT vectors
$${b}_{f} = {\frac{1}{x} [ {e}^{f \frac{j 2π0}{{N}_{3}}} , {e}^{f \frac{j 2π1}{{N}_{3}}} , … , {e}^{f \frac{j 2π ( {N}_{3} - 1 )}{{N}_{3}}} ]}^{T} ,$$
wherein f=0,1, . . . , N₃−1.

16. The BS of claim 9, wherein N=min(N₃, K), where K is configured via the information.

17. A method for operating a user equipment (UE), the method comprising:
receiving information about a channel state information (CSI) report, the information including information about two numbers for basis vectors, N and M_{ν}, where N≥M_{ν};
identifying N consecutive basis vectors with indices Mᵢₙᵢₜ+i, i=0,1, . . . , N−1 starting at index Mᵢₙᵢₜ, wherein the N consecutive basis vectors belong to a set of N₃ basis vectors, and N≤N₃;
determining M_{ν} basis vectors, wherein:
when N=M_{ν}, the M_{ν} basis vectors=the N consecutive basis vectors, and
when N>M_{ν}, the M_{ν} basis vectors are selected from the N consecutive basis vectors;
determining the CSI report based on the M_{ν} basis vectors, wherein when N>M_{ν}, the CSI report includes an indicator indicating an information about the selected M_{ν} basis vectors; and
transmitting the CSI report including the indicator indicating the information about the selected M_{ν} basis vectors when N>M_{ν}.

18. The method of claim 17, wherein Mᵢₙᵢₜ=0.

19. The method of claim 18, wherein when N>M_{ν},
one of the M_{ν} basis vectors is fixed and corresponds to index i=0,
the information about the selected M_{ν} basis vectors corresponds to the remaining M_{ν} −1 basis vectors, and
the indicator indicates M_{ν} −1 out of remaining N−1 basis vectors with indices i=1, . . . , N−1, and includes
$$⌈ {log}_{2} ( \begin{matrix}N - 1 \\ {M}_{v} - 1\end{matrix} ) ⌉$$
bits for reporting, where ┌ ┐ is a ceiling function.

20. The method of claim 19, wherein:
when M_{ν} =2, N is configured via a higher layer signaling from {2, x}, where x is a value larger than 2, and
when N=x, the indicator indicates a second basis vector out of remaining N−1 basis vectors, and includes ┌log₂(N−1)┐ bits for reporting, where ┌ ┐ is a ceiling function.
